(19) United States
(12) Patent Application Publication
(10) Pub. No.: US 2016/0319191 A1
(43) Pub. Date: Nov. 3, 2016

(54) NEMATIC LIQUID-CRYSTAL COMPOSITION AND LIQUID-CRYSTAL DISPLAY ELEMENT OBTAINED USING SAME

(71) Applicant: DIC Corporation, Tokyo (JP)

(72) Inventors: Shinichi Hirata, Kita-adachi-gun (JP); Go Sudo, Kitaadachi-gun (JP); Shotaro Kawakami, Kita-adachi-gun (JP)

(73) Assignee: DIC Corporation, Tokyo (JP)

(21) Appl. No.: 14/898,544

(22) PCT Filed: Mar. 6, 2014
(86) PCT No.: PCT/JP2014/055823

§ 371 Date: Jun. 21, 2016

(30) Foreign Application Priority Data
Jun. 17, 2013 (JP) 2013-126572

(51) Int. Cl. C09K 19/32; C09K 19/02; C09K 19/54; C09K 19/30

(52) U.S. Cl. CPC C09K 19/322; C09K 19/3003; C09K 19/0216; C09K 19/542; C09K 2019/3004; C09K 2019/3009; C09K 2019/301; C09K 2019/3016; C09K 2019/548

(57) ABSTRACT

A task to be achieved by the present invention is to provide a liquid crystal composition which has a satisfactorily low solid phase-nematic phase transition temperature (Tₒₙ), a satisfactorily small viscosity (η), a satisfactorily small rotational viscosity (γ1), a large elastic constant (K₃₃), and a negative dielectric anisotropy (Δε), the absolute value of which is large, without having lowered the refractive index anisotropy (Δn) and nematic phase-isotropic liquid phase transition temperature (Tₙᵢ), and further to provide a liquid crystal display element of a VA mode or the like using the same, which has excellent display quality such that the element is free of or has suppressed a display failure, and which has high response speed. Provided are a liquid crystal composition comprising one kind or two or more kinds of compounds having an alkenyl side chain in the liquid crystal composition, wherein the total content of the compounds having an alkenyl side chain in the liquid crystal composition is from 5 to 100% by mass, and a liquid crystal display element using the same.

### TECHNICAL FIELD

The present indention relates to a nematic liquid crystal composition of which a dielectric anisotropy (Δε) is a negative value, and which is useful as a liquid crystal display material, and a liquid crystal display element using the same.

### BACKGROUND ART

Liquid crystal display elements have been used in a clock and a calculator, and a variety of household appliances, a measuring apparatus, a panel for automobile, a word processor, a personal organizer, a printer, a computer, a television (TV) set, and the like. As representative examples of liquid crystal display systems, there can foe mentioned those of a TN (twisted nematic) mode, an STH (super twisted nematic) mode, a DS (dynamic light scattering) mode, a GH (guest-host) mode, an IPS (in-plane switching) mode, an OCB (optically compensated birefringence) mode, an ECB (electrically controlled birefringence) mode, a VA (vertical alignment) mode, a CSH (color super homeotropic) mode, or an FLC (ferroelectric liquid crystal). Further, as examples of driving systems for liquid crystal display, there can be mentioned static driving, multiplex driving, a passive matrix system, and an active matrix (AM) driving system by a TFT (thin film transistor), a TFD (thin film diode), or the like.

In these display systems, those of an IPS mode, an ECB mode, a VA mode, a CSH mode, or the like have a feature such that a liquid crystal material having a negative Δε value is used. Of these, particularly, a VA mode display system by AM driving is used in a display element required to have a high speed and a wide view angle, for example, in applications of a TV set and the like.

A nematic liquid crystal composition used in the display system of a VA mode or the like is required to achieve low-voltage driving and high-speed response as well as a wide range of the operating temperature. Specifically, the liquid crystal composition is required to have a Δε, which is negative and the absolute value of which is large, and a low viscosity as well as a high nematic phase-isotropic liquid phase transition, temperature (Tₙᵢ). Further, Δn×d, which is a product of a refractive index anisotropy (Δn) and a cell gap (d), is needed to be set so that the Δn of the liquid crystal material falls in an appropriate range according to the cell gap. In addition, when the liquid crystal display element is applied to a TV set or the like, high-speed response is regarded as being more important, and therefore a liquid crystal material having a low viscosity (η) is required.

The liquid crystal composition has been improved in properties making studies on various compounds having a Δε which is negative and the absolute value of which is large.

As a liquid crystal material having a negative Δε, a liquid crystal composition using compounds (A) and (B) having a 2,3-difluorophenylene skeleton shown below (see PTL 1) has been disclosed.

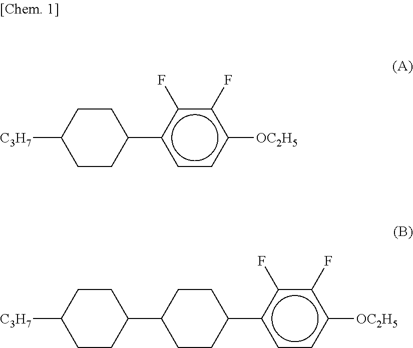

In this liquid crystal composition, compounds (C) and (D) are used as a compound having a Δε which is almost 0. However, the liquid crystal composition has not achieved a satisfactorily low viscosity satisfying the liquid crystal composition required to have high-speed response for liquid crystal television or the like.

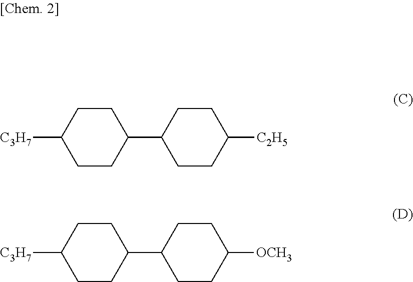

On the other hand, a liquid crystal composition using a compound represented by the formula (E) below has been disclosed. This liquid crystal composition is, however, a liquid crystal composition using the compound of formula (E) and the above-mentioned compound (D) in combination and having a small Δn (see PTL 2) or a liquid crystal composition having added thereto a compound having an alkenyl group in the molecule thereof (alkenyl compound), such as a compound (F) below, for improving the response speed (see PTL 3), and further studies are needed for achieving the liquid crystal composition having both high Δn and high reliability.

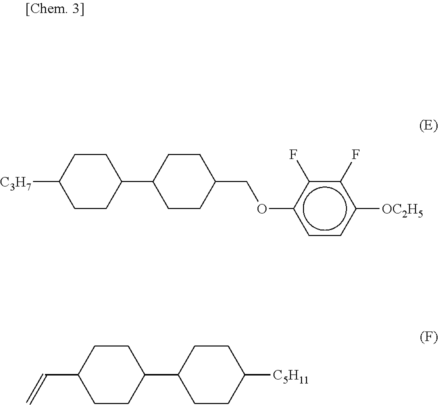

Further, a liquid crystal composition using a compound represented by the formula (G) below has been disclosed (see PTL 4), and this liquid crystal composition is also a liquid crystal composition containing compounds including an alkenyl compound, such as the above-mentioned compound (F), and therefore has a disadvantage in that a display failure, such as burning or display unevenness, is likely to he caused.

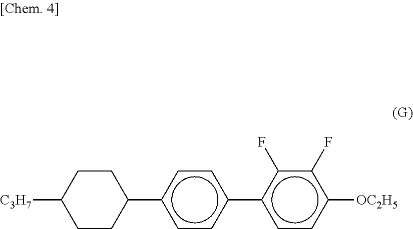

The influence of the liquid crystal composition containing an alkenyl compound on a display failure has been disclosed (see PTL 5), and generally, as the amount of the alkenyl compound contained is reduced, the liquid crystal composition is increased in its η, making it difficult to achieve high-speed response, and therefore it has been difficult to both suppress the display failure and achieve high-speed response.

As mentioned above, merely by using a compound having a negative Δε value and the compounds (C), (D), and (F) in combination, the development of a liquid crystal composition having a negative Δε, which composition has both a high Δn and a low η, and which is free of or has suppressed a display failure, has been difficult.

Moreover, a liquid crystal composition using a combination of the formulae (A) and (G) with the formula (III-F31) below having a Δε which is almost aero (see PTL 6) has been disclosed. However, in the production process for a liquid crystal display element, the compound having a low vapor pressure disadvantageously volatilizes under an extremely low pressure upon injecting the liquid crystal composition into a liquid crystal cell, and therefore it has been considered that the content of such a compound in the liquid crystal composition cannot be increased. For this reason, the above liquid crystal composition has a limited content of the formula (III-F31), and thus poses a problem in that, although it has a large Δn, it has an extremely high viscosity.

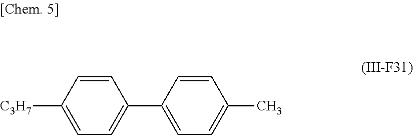

Further, PTL 6 and PTL 7 have already disclosed a liquid crystal composition using a compound having a terphenyl structure substituted with fluorine.

In addition, PTL 8 has disclosed that, by using a liquid crystal material having a large index (FoM) indicated by the (Equation 1) below, a homeotropic liquid crystal cell is improved in the response speed. However, the improvement of the response speed of the liquid crystal composition described in the specification of PTL 8 is not satisfactory.

[Math. 1]

FoM=K₃₃·Δn²/γ1 (Equation 1)

K₃₃: Elastic constant
Δn: Refractive index anisotropy
γ1: Rotational viscosity

As apparent from the above, with respect to the liquid crystal composition required to achieve high-speed response for a liquid crystal television and the like, there has been desired a liquid crystal composition which has a satisfactorily low solid phase-nematic phase transition temperature (Tₒₙ), a satisfactorily small viscosity (η), a satisfactorily small rotational viscosity (γ1), and a large elastic constant (K₃₃) without having lowered the refractive index anisotropy (Δn) and nematic phase-isotropic liquid phase transition temperature (Tₙᵢ).

### CITATION LIST

### Patent Literature

PTL 1: JP-A-8-104869

PTL 2: European Patent Application Publication No. 0474062

PTL 3: JP-A-2006-37054

PTL 4: JP-A-2001-354967

PTL 5: JP-A-2008-144135

PTL 6: WO2007/077872

PTL 7: JP-A-2003-327965

PTL 8: JP-A-2006-301643

### SUMMARY OF INVENTION

### Technical Problem

A task to be achieved by the present invention is to provide a liquid crystal composition which has a satisfactorily low solid phase-nematic phase transition temperature (Tₒₙ), a satisfactorily small viscosity (η), a satisfactorily small rotational viscosity (γ1), a large elastic constant (K₃₃), and a negative dielectric anisotropy (Δε), the absolute value of which is large, without having lowered the refractive index anisotropy (Δn) and nematic phase-isotropic liquid phase transition temperature (Tₛᵢ), and further to provide a liquid crystal display element or a VA mode or the like using the composition, which has excellent display quality such that the element is free of or has suppressed a display failure, and which has high response speed.

### Solution to Problem

The present inventor has made studies on compounds having various kinds of alkyl side chains and alkenyl side chains, and has found that the above-mentioned task can be achieved by using specific compounds in combination, and the present invention has been completed.

In the invention, there are provided a liquid crystal composition which contains one kind or two or more kinds of compounds having an alkenyl side chain in the liquid crystal composition, wherein the total content of the compounds having an alkenyl side chain in the liquid crystal composition is from 5 to 100% by mass, and a liquid crystal display element using the same.

### Advantageous Effects of Invention

The liquid crystal composition of the invention has a satisfactorily low solid phase-nematic phase transition temperature (Tₒₙ), a satisfactorily small viscosity (η), a satisfactorily small rotational viscosity (γ1), a large elastic constant (K₃₃), a high voltage holding ratio (VHR), and a negative dielectric anisotropy (Δε), the absolute value of which is large, without having lowered the refractive index anisotropy (Δn) and nematic phase-isotropic liquid phase transition temperature (Tₙᵢ), and therefore a liquid crystal display element of a VA mode, a PSA mode, or the like using the composition has excellent, display quality such that the element is free or has suppressed a display failure, and has high response speed.

### DESCRIPTION OF EMBODIMENTS

[1] A liquid crystal composition containing one kind or two or more kinds of compounds having an alkenyl side chain in the liquid crystal composition, wherein the total content of the compounds having an alkenyl side chain in the liquid crystal composition is from 5 to 100% by mass.

[2] The liquid crystal composition according to the item [1] above, wherein the total content of compounds having a 1-propenyl group in the compounds having an alkenyl side chain in the liquid crystal composition is from 5 to 100% by mass.

[3] The liquid crystal composition according to claim 2, wherein the compound having a 1-propenyl group in the item [2] is one kind or two or more kinds of compounds selected from the group consisting of a compound represented by the following general formula (I) and a compound represented by the following general formula (I-n);

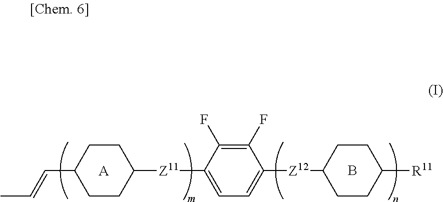

wherein R¹¹ represents an alkyl group having 1 to 8 carbon atoms, an alkoxy group having 1 to 8 carbon atoms, an alkenyl group having 3 to 8 carbon atoms or an alkenyloxy group having 2 to 8 carbon atoms, —CH₂— or two or more —CH₂— which are not adjacent to each other, in the group each independently may be substituted with —O— or —S—, and one hydrogen atom or two or more hydrogen atoms present in the group each independently may be substituted with a fluorine atom or a chlorine atom;

each of m and n independently represents 0, 1, or 2, with the proviso that m+n is 1, 2, 3, or 4;

each of Z¹¹ and Z¹² independently represents —OCH₂—, —CH₂O—, —CF₂O—, —OCF₂—, —CH₂CH₂—, —CF₂CF₂— or a single bond, and when plural Z¹¹'s and Z¹²'s are present, they may be the same or different; and

each of ring A and ring B independently represents a trans-1,4-cyclohexylene group, a 1,4-phenylene group, a 2-fluoro-1,4-phenylene group, a 3-fluoro-1,4-phenylene group, a 3,5-difluoro-1,4-phenylene group, a 2,3-difluoro-1,4-phenylene group, a 1,4-cyclohexenylene group, a 1,4-bicyclo[2.2.2]octylene group, a piperidine-1,4-diyl group, a naphthalene-2,6-diyl group, a decahydronaphthalene-2,6-diyl group, or a 1,2,3,4-tetrahydronaphthalene-2,6-diyl group, and when plural rings A or plural rings B are present, they may be the same or different;

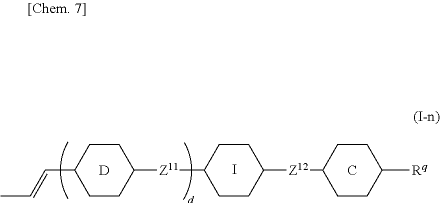

wherein R^{q} represents an alkyl group having 1 to 8 carbon atoms, an alkoxy group having 1 to 8 carbon atoms, an alkenyl group having 3 to 8 carbon atoms, or an alkenyloxy group having 2 to 8 carbon atoms, and —CH₂— or two or more —CH₂—, which are not adjacent to each other, in the group each independently may be substituted with —O— or —S—, and one hydrogen atom or two or more hydrogen atoms present in the group independently may be substituted with a fluorine atom or a chlorine atom;

each of Z¹¹ and Z¹² independently represents —OCH₂—, —CH₂O—, —CF₂O—, —OCF₂—, —CH₂CH₂—, —CF₂CF₂— or a single bond, wherein plural Z¹¹'s and plural Z¹²'s are present, they may be the same or different;

d represents 0, 1, or 2; and

each of ring D, ring I and ring C independently represents a trans-1,4-cyclohexylene group, a 1,4-phenylene group, a 2-fluoro-1,4-phenylene group or a 3-fluoro-1,4-phenylene group, and when plural rings D are present, they may be the same or different.

[4] The liquid crystal composition according to the item [3] above, which contains one kind or two or more kinds of the compounds represented by the general formula (I).

[5] The liquid crystal composition according to the item [3] above, which contains one kind or two or more kinds of the compounds represented by the general formula (I-n).

[6] The liquid crystal composition according to the item [3] above, which contains one kind, or two or more kinds of the compounds represented by the general formula (I) and one kind or two or more kinds of the compounds represented by the general formula (I-n).

[7] The liquid crystal composition according to any one of the items [1] to [6] above, which further contains one kind or two or more kinds of compounds represented by the following general formula (N3):

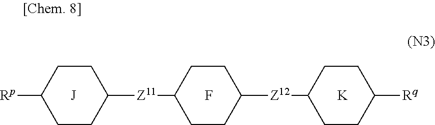

wherein each of R^{p} and R^{q} independently represents an alkyl group having 1 to 10 carbon atoms, an alkoxy group having 1 to 10 carbon atoms, an alkenyl group having 2 to 10 carbon atoms, or an alkenyloxy group having 2 to 10 carbon atoms, and —CH₂— or two or more —CH₂—, which are not adjacent to each other, in the group each independently may be substituted with —O— or —S—; and one hydrogen atom or two or more hydrogen atoms present in the group each independently may fee substituted with a fluorine atom or a chlorine atom; each of ring J, ring F and ring K independently represents a trans-1,4-cyclohexylene group, a 1,4-phenylene group, a 2-fluoro-1,4-phenylene group, a 3-fluoro-1,4-phenylene group, a 3,5-difluoro-1,4-phenylene group, a 1,4-cyclohexenylene group, a 1,4-bicyclo[2.2.2]octylene group, a piperidine-1,4-diyl group, a naphthalene-2,6-diyl group, a decahydronaphthalene-2,6-diyl group, or a 1,2,3,4-tetrahydronaphthalene-2,6-diyl group; and each of Z¹¹ and Z¹² independently represents —OCH₂—, —Ch₂O—, —CF₂O—, —OCF₂—, —CH₂CH₂—, —CF₂CF₂— or a single bond, and when plural Z¹¹'s or plural Z¹²'s are present, they may be the same or different, with the proviso that the compound represented by the general formula (I-n) in claim 3 is excluded.

[8] The liquid crystal composition according to any one of the items 1 to 10 above, which further contains one kind or two or more kinds of compounds represented by the following general formula (11):

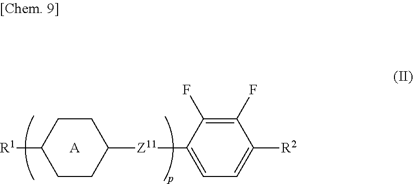

wherein each of R¹ and R² independently represents an alkyl group having 1 to 10 carbon atoms, an alkoxy group having 1 to 10 carbon atoms, an alkenyl group having 2 to 10 carbon atoms or an alkenyloxy group having 2 to 10 carbon atoms; one —CH₂— or two or more —CH₂—, which are not adjacent to each other, present in the group each independently may be substituted with —O— or —S—; one hydrogen atom or two or more hydrogen atoms present in the group each independently may be substituted with a fluorine atom or a chlorine atom; ring A each independently represents a trans-1,4-cyclohexylene group, a 1,4-phenylene group, a 2-fluoro-1,4-phenylene group, a 3-fluoro-1,4-phenylene group, a 3,5-difluoro-1,4-phenylene group, a 2,3-difluoro-1,4-phenylene group, a 1,4-cyclohexenylene group, a 1,4-bicyclo[2.2.2]octylene group, a piperidine-1,4-diyl group, a naphthalene-2,6-diyl group, a decahydronaphthalene-2,6-diyl group, or a 1,2,3,4-tetrahydronaphthalene-2,6-diyl group; p represents 1, 2, or 3 and when plural rings A are present, they may be the same or different; and Z¹¹ represents —OCH₂—, —CH₂O—, —CF₂O—, —OCF₂—, —CH₂CH₂-, —CF₂CF₂— or a single bond and when plural Z¹¹'s are present, they may be the same or different, with the proviso that the compound represented by the general formula (I) in claim 3 is excluded.

[9] The liquid crystal composition according to any one of the items [1] to [8] above, which further contains one kind or two or more kinds of compounds selected from, the group consisting of compounds represented by the following general formulae (IV-1) to (IV-3):

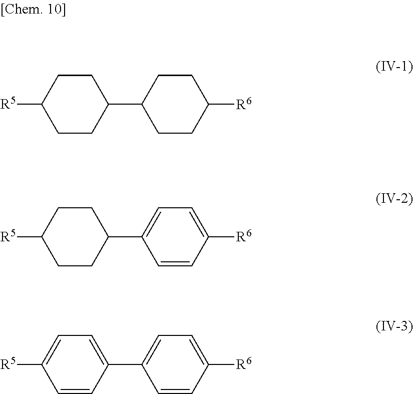

wherein R⁵ represents an alkyl group having 1 to 5 carbon atoms or an alkenyl group having 2 to 5 carbon atoms, and R⁶ represents an alkyl group having 1 to 5 carbon atoms, an alkoxy group having 1 to 5 carbon atoms, an alkenyl group having 2 to 5 carbon atoms or an alkenyloxy group having 2 to 5 carbon atoms; one —CH₂— or two or more —CH₂—, which are not adjacent to each other, present in the group each independently may be substituted with —O— or —S—; one hydrogen atom or two or more hydrogen atoms present in the group each independently may be substituted with a fluorine atom, with the proviso that the compound represented by the general formula (I-n) in claim 3 is excluded.

[10] The liquid crystal composition according to any one of the items [1] to [9] above, which further contains one kind or two or more kinds of compounds represented by the following general formula (V):

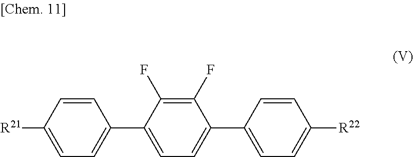

wherein each of R²¹ and R²² independently represents an alkyl group having 1 to 8 carbon atoms, an alkoxy group having 1 to 8 carbon atoms, an alkenyl group having 2 to 8 carbon atoms or an alkenyloxy group having 2 to 8 carbon atoms, one —CH₂— or two or more —CH₂—, which are not adjacent to each other, present in the group each independently may be substituted with —O— or —S—, and one hydrogen atom or two or more hydrogen atoms present in the group each independently may be substituted with a fluorine atom, with the proviso that the compound represented by the general formula (I) in claim 3 is excluded.

[11] The liquid crystal composition according to any one of the items [1] to [10] above, which further contains one kind or two or more kinds of polymerizable compounds.

[12] The liquid crystal composition according to claim 11, wherein the polymerizable compound is a compound represented by the following general formula (RM-1):

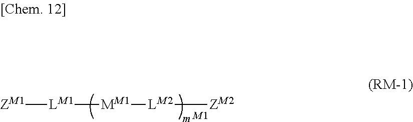

wherein each of Z^{M1} and Z^{M2} independently represents the following:

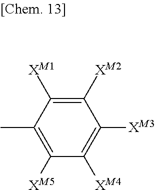

wherein X^{M1} to X^{M5} represent a hydrogen atom, a fluorine atom, or the following:

-S^{M1}-R^{M1}, [Chem. 14]

with the proviso that at least one of X^{M1} to X^{M5} represents the following:

-S^{M1}-R^{M1} [Chem. 15]

wherein S^{M1} represents an alkylene group having 1 to 12 carbon atoms or a single bond, —CH₂— in the alkylene group may be substituted with an oxygen atom, —COO—, —OCO— or —OCOO—, with the proviso that oxygen atoms are not directly bonded to each other; and R^{M1} represents any of the following formulae (R-1) to (R-15):

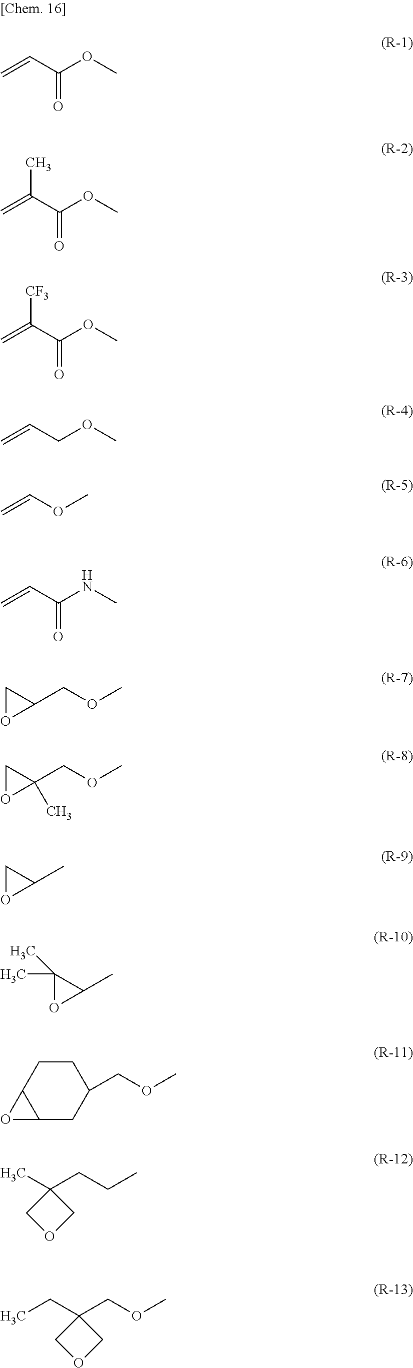

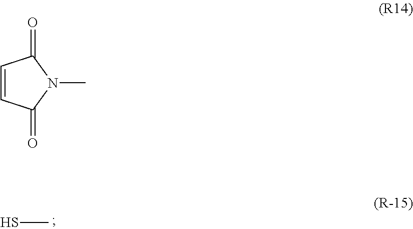

each of L^{M1} and L^{M2} independently represents a single bond, —O—, —CH₂—, —OCH₂—, —CH₂O—, —CO—, —C₂H₄—, —COO—, —OCO—, —CH═CH—COO—, —COO—CH═CH—, —OCO—CH═CH—, —CH═CH—OCO—, —COOC₂H₄—, —OCOC₂H₄—, —C₂H₄OCO—, —C₂H₄COO—, —OCOCH₂—, —CH₂COO—, —CH═CH—, —CF═CH—, —CH═CF—, —CF═CF—, —CF₂—, —CF₂O—, —OCF₂—, —CF₂CH₂—, —CH₂CF₂—, —CF₂CF₂— or —C≡C— and when plural L^{M2}'s are present, they may be the same or different;

M^{M1} represents a 1,4-phenylene group, a 1,4-cyclohexylene group, or a naphthalene-2,6-diyl group, and M^{M1} each independently may be unsubstituted or a hydrogen atom contained in the group may be substituted with a fluorine atom, a chlorine atom, an alkyl group, a halogenated alkyl group, a halogenated alkoxy group or an alkoxy group, each having 1 to 8 carbon atoms, a nitro group or the following:

-S^{M1}-R^{M1}; and [Chem. 17]

m^{M1} represents 0, 1, or 2, with the proviso that X^{M1}'s to X^{M5}'s, S^{M1}'s, R^{M1}'s, L^{M2}'s and/or M^{M1}'s are present plurally, they may be the same or different.

[13] The liquid crystal composition according to any one of the items [1] to [13] above, which has a dielectric anisotropy (Δε) at 25° C. in the range of from −2.0 to −8.0, a refractive index anisotropy (Δn) at 20° C. in the range of from 0.08 to 0.14, a viscosity (η) at 20° C. in the range of from 5 to 30 mPa·s, a rotational viscosity (γ1) at 20° C. in the range of from 50 to 150 mPa·s, and a nematic phase-isotropic liquid phase transition temperature (Tₙᵢ) in the range of from 60 to 120° C.

[14] A liquid crystal display element using the liquid crystal composition according to any one of the items [1] to [13] above.

[15] A liquid crystal display element for active matrix driving, using the liquid crystal composition according to any one of the items [1] to [13] above.

[16] A liquid crystal display element for a VA mode, a PSA mode, a PSVA mode, an IPS mode, or an ECB mode, using the liquid crystal composition according to any one of the items [1] to [13] above.

The liquid crystal composition of the invention contains one kind or two or more kinds of compounds having an alkenyl side chain, and the content of the compound(s) having an alkenyl side chain in the liquid crystal composition is from 5 to 100% by mass, preferably from 5 to 90% by mass, further preferably from 5 to 80% by mass, especially preferably from 5 to 70% by mass.

When the reduction of the viscosity is regarded as being more important, the content of the compound having an alkenyl side chain is preferably larger, and the lower limit of the content is preferably 5%, preferably 8%, preferably 10%, preferably 15%, preferably 20%, preferably 25%, preferably 30%. When the stability of the liquid crystal composition is regarded as being more important, the content of the compound having an alkenyl side chain is preferably smaller, and the upper limit of the content is preferably 100%, preferably 95%, preferably 80%, preferably 75%, preferably 70%, preferably 65%, preferably 60%, preferably 55%, preferably 50%, preferably 45%, preferably 40%.

The proportion of the total mass Of the compounds having a 1-propenyl group as a side chain to the total mass of the compounds having an alkenyl side chain as a side chain contained in the liquid crystal composition is preferably from 30 to 100% by mass, preferably from 35 to 100% by mass, further preferably from 40 to 100% by mass, especially preferably from 60 to 100% by mass. When the reliability of the liquid crystal composition is regarded as being more important, the lower limit of the proportion is preferably larger, and the lower limit is preferably 30%, preferably 35%, preferably 40%, preferably 45%, preferably 50%, preferably 55%, preferably 60%, preferably 63%, preferably 65%, preferably 68%, preferably 70%, preferably 73%, preferably 75%, preferably 78%, preferably 80%, preferably 83%, preferably 65%, preferably 86%, preferably 90%, preferably 93%, preferably 95%, preferably 96%, preferably 97%, preferably 98%, preferably 99%, preferably 100%, and it is preferred that substantially only the compound having a 1-propenyl group is contained as the compound having an alkenyl side chain. Here the “substantially” means that all the compounds intentionally added as a non-polymerizable low-molecular compound having an alkenyl side chain are the compound having a 1-propenyl group, except the compounds inevitably mixed in the production step. The upper limit of the proportion is preferably 95%, preferably 97%, preferably 98%, preferably 99%, preferably 100%, and it is preferred that substantially only the compound having a 1-propenyl group is contained.

As the compound having a 1-propenyl group, a compound represented by the following general formula (I):

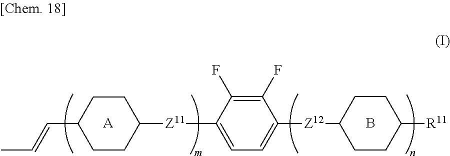

is preferred.

In the general formula (I) above, R¹¹ represents an alkyl group having 1 to 8 carbon atoms, an alkoxy group having 1 to 8 carbon atoms, an alkenyl group having 2 to 8 carbon atoms, or an alkenyloxy group having 3 to 8 carbon atoms, especially preferably represents a linear alkyl group having 1 to 5 carbon atoms, a linear alkoxy group having 1 to 5 carbon atoms, or a linear alkenyl group having 2 to 5 carbon atoms. —CH₂— or two or more —CH₂—, which are not adjacent to each other, in the group may be each independently substituted with —O— or —S—, and one hydrogen atom or two or more hydrogen atoms present in the group may be each independently substituted with a fluorine atom or a chlorine atom. R¹¹ is preferably linear, and preferably unsubstituted. When R¹¹ represents an alkenyl group, as the alkenyl group, substituents represented by the following formulae (Alkenyl-2) to (Alkenyl-4) are preferred:

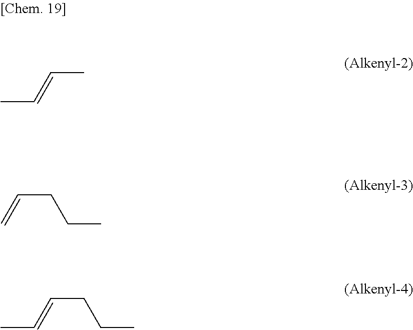

wherein the alkenyl is bonded at the right end thereof to the ring structure.

Each of Z¹¹ and Z¹² independently represents —OCH₂—, —CH₂O—, —CF₂O—, —OCF₂—, —CH₂CH₂—, —CF₂CF₂— or a single bond, preferably represents —CH₂O—, —CF₂O— or a single bond, further preferably represents —CH₂O— or a single bond.

Each of ring A and ring B independently represents a trans-1,4-cyclohexylene group, a 1,4-phenylene group, a 2-fluoro-1,4-phenylene group, a 3-fluoro-1,4-phenylene group, a 3,5-difluoro-1,4-phenylene group, a 2,3-difluoro-1,4-phenylene group, a 1,4-cyclohexenylene group, a 1,4-bicyclo[2.2.2]octylene group, a piperidine-1,4-diyl group, a haphthalene-2,6-diyl group, a decahydronaphthalene-2,6-diyl group, or a 1,2,3,4-tetrahydronaphthalene-2,6-diyl group, preferably represents a trans-1,4-cyclohexylene group, a 1,4-phenylene group, a 2-fluoro-1,4-phenylene group, a 3-fluoro-1,4-phenylene group, a 3,5-difluoro-1,4-phenylene group, or a 2,3-difluoro-1,4-phenylene group, further preferably represents a trans-1,4-cyclohexylene group or a 1,4-phenylene group. Each of m and n independently represents 0, 1, or 2, preferably represents 0 or 1, and m+n is preferably 1 or 2.

The compound represented by the general formula (I) is preferably, for example, the general formula (I-A1), (I-B1), (I-C1), (I-D1), (I-E1), (I-A2), (I-B2), (I-C2), (I-D2), (I-E2), (I-AA), (I-AB), (I-BA), or (I-BB).

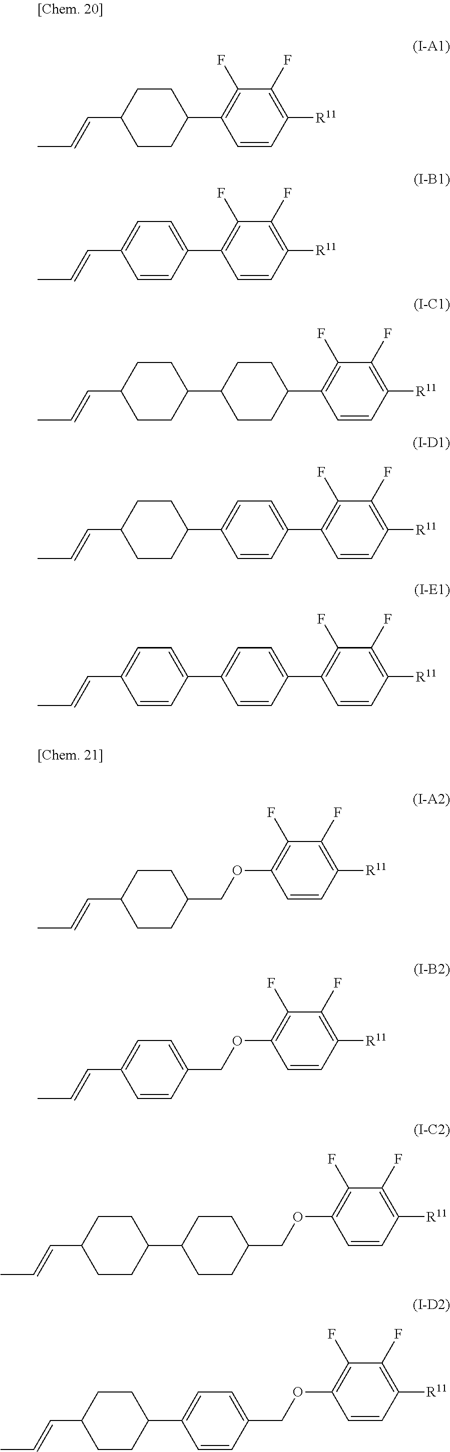

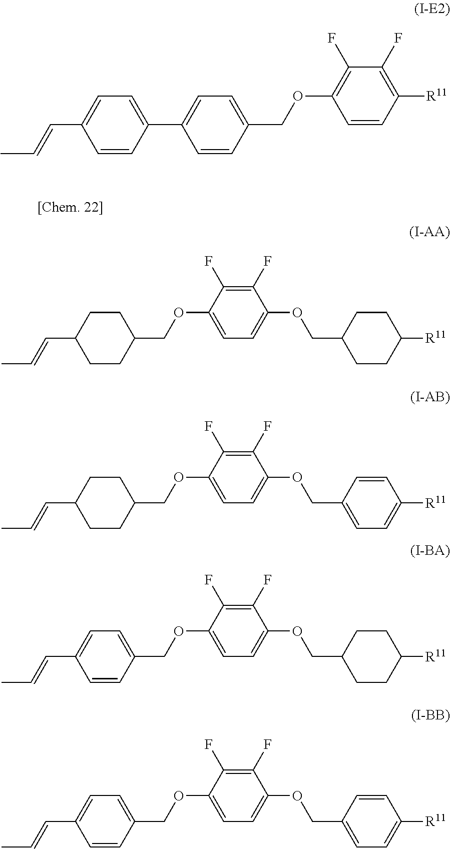

In the above formulae, R¹¹ is as defined above, and the general formulae (I-AB) and (I-BA) do not represent the same compound.

As the compound having a 1-propenyl group, a compound represented by the following general formula (I-n):

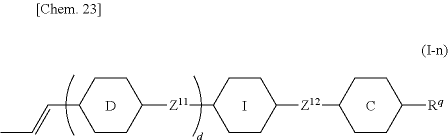

is preferred.

In the general formula (I-n) above, R^{q} each independently represents an alkyl group having 1 to 8 carbon atoms, an alkoxy group having 1 to 8 carbon atoms, an alkenyl group having 2 to 8 carbon atoms, or an alkenyloxy group having 2 to 8 carbon atoms, especially preferably represents a linear alkyl group having 1 to 5 carbon atoms, a linear alkoxy group having 1 to 5 carbon atoms, or a linear alkenyl group having 2 to 5 carbon atoms. —CH₂— or two or more —CH₂—, which are not adjacent to each other, in the group may be each independently substituted with —O— or —S—, and one hydrogen atom or two or more hydrogen atoms present in the group may be each independently substituted with a fluorine atom or a chlorine atom. R^{q} is preferably linear, and preferably unsubstituted. When R^{q} represents an alkenyl group, as the alkenyl group, substituents represented by the following formulae (Alkenyl-2) to (Alkenyl-4) are preferred:

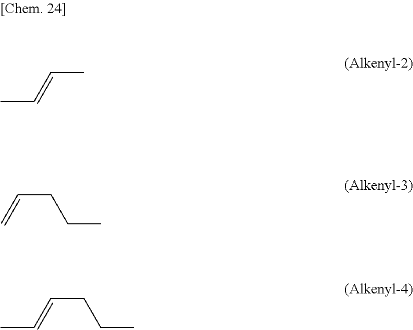

wherein the alkenyl is bonded at the right end thereof to the ring structure.

Each of ring D, ring I and ring C independently preferably represents a trans-1,4-cyclohexylene group, a 1,4-phenylene group, a 2-fluoro-1,4-phenylene group, or a 3-fluoro-1,4-phenylene group.

Each of Z¹¹ and Z¹² independently represents —OCH₂—, —CH₂O—, —CF₂O—, —OCF₂—, —CH₂CH₂—, —CF₂CF₂— or a single bond, preferably represents —CH₂O—, —CF₂O— or a single bond, further preferably represents —CH₂O— or a single bond.

Z¹¹ and Z¹² in the general formulae (I) and (I-n) may be the same or different.

d represents 0, 1, or 2, preferably 0 or 1.

Specifically, as the compound of the general formula (I-n), compounds represented by the following general formulae (I-n1) to (I-n8):

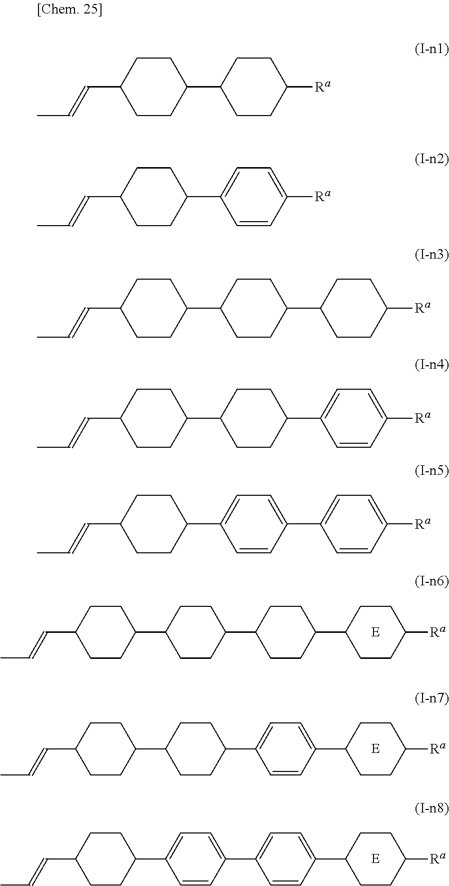

are preferred. In the above formulae, R^{a} has the same meaning as that of R^{q}, and ring E represents a trans-1,4-cyclohexylene group or a 1,4-phenylene group. Hydrogen atoms in the rings of the general formulae (I-n1) to (I-n8) may be independently substituted with a fluorine atom.

The compound of the general formula (I-n) is further preferably a compound represented by the general formula (I-n1), general formula (I-n2), general formula (I-n4), or general formula (I-n5), especially preferably a compound represented by the general formula (I-n1), general formula (I-n4), or general formula (I-n5). When the liquid crystal composition is required to have a high Tni, the composition preferably contains, in addition to a compound represented by the general formula (I-n1), general formula (I-n4), or general formula (I-n5), partially a compound represented by the general formula (I-n6), general formula (I-n7), or general formula (I-n8).

The liquid crystal compound can further contain one or more kinds of compounds having a Δε which is negative, and the absolute value of which is larger than 3, preferably contains one kind to 15 kinds of the compounds, further preferably contains one kind to 10 kinds of the compounds, especially preferably contains 2 to 10 kinds of the compounds. The total content of these compounds is preferably from 5 to 90% by mass, further preferably from 10 to 70% by mass, especially preferably from 10 to 50% by mass.

The compound represented by the general formula (I) is excluded.

As the compound having a Δε which is negative, and the absolute value of which is larger than 3, preferred is a compound represented by the following general formula (II).

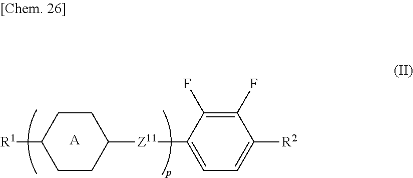

In the above formula, each of R¹ and R² independently represents an alkyl group having 1 to 10 carbon atoms, an alkoxy group having 1 to 10 carbon atoms, an alkenyl group having 2 to 10 carbon atoms, or an alkenyloxy group having 2 to 10 carbon atoms, and one —CH₂— or two or more —CH₂—, which are not adjacent to each other, present in the group may be each independently substituted with —O— or —S—, and one hydrogen atom or two or more hydrogen atoms present in the group may be each independently substituted with a fluorine atom or a chlorine atom. R¹ and R² are preferably linear, and preferably unsubstituted. When R¹ and R² represent an alkenyl group, as the alkenyl group, substituents represented by the following formulae (Alkenyl-2) to (Alkenyl-4) are preferred:

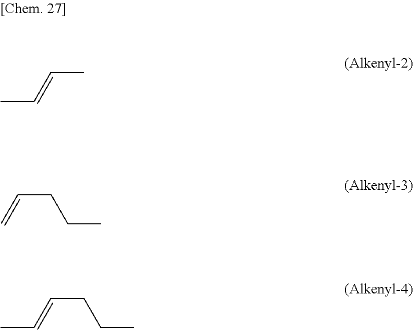

wherein the alkenyl is bonded at the right end thereof to the ring structure.

Ring A represents a trans-1,4-cyclohexylene group, a 1,4-phenylene group, a 2-fluoro-1,4-phenylene group, a 3-fluoro-1,4-phenylene group, a 3,5-difluoro-1,4-phenylene group, a 2,3-difluoro-1,4-phenylene group, a 1,4-cyclohexenylene group, a 1,4-bicyclo[2.2.2]octylene group, a piperidine-1,4-diyl group, a naphthalene-2,6-diyl group, a decahydronaphthalene-2,6-diyl group, or a 1,2,3,4-tetrahydronaphthalene-2,6-diyl group, preferably represents a trans-1,4-cyclohexylene group, a 1,4-phenylene group, a 2-fluoro-1,4-phenylene group, a 3-fluoro-1,4-phenylene group, a 3,5-difluoro-1,4-phenylene group, or a 2,3-difluoro-1,4-phenylene group, further preferably represents a trans-1,4-cyclohexylene group or a 1,4-phenylene group. p represents 0, 1, or 2, further preferably 0 or 1. When p represents 2 and two rings A are present, they may be the same or different.

Z¹¹ represents —OCH₂—, —CH₂O—, —CF₂O—, —OCF₂—, —CH₂CH₂—, —CF₂CF₂— or a single bond, preferably represents —CH₂O—, —CF₂O— or a single bond, further preferably represents —CH₂O— or a single bond.

In the above formula, each of R¹ and R² independently further preferably represents an alkyl group having 1 to 5 carbon atoms, an alkoxy group having 1 to 5 carbon atoms, an alkenyl group having 2 to 5 carbon atoms, or an alkenyloxy group having 2 to 5 carbon atoms, and R¹ is especially preferably an alkyl group having 1 to 5 carbon atoms or an alkenyl group having 2 to 5 carbon atoms, and R² is especially preferably an alkoxy group having 1 to 5 carbon atoms, and is preferably linear.

As the compound of the general formula (II), preferred, are compounds represented by the general formulae (II-A1) to (II-A5) and general formulae (II-B1) to (II-B5), and of these, the compounds of the general formulae (II-A1) to (II-A5) are further preferred, and the compound of the general formula (II-A1) or general formula (II-A3) is especially preferred.

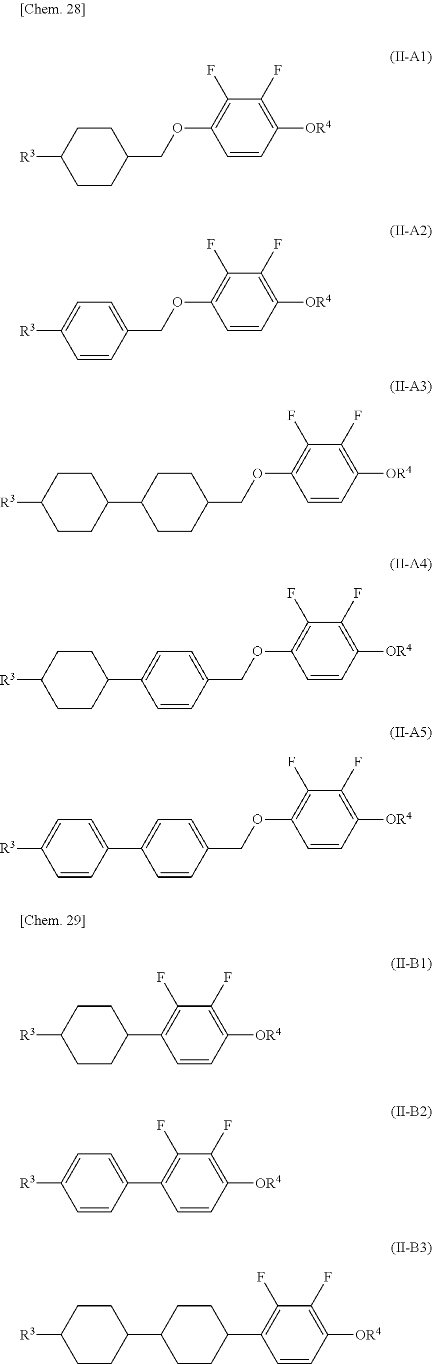

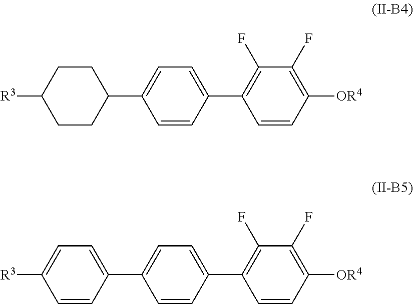

In the above formulae, each of R³ and R⁴ independently represents an alkyl group having 1 to 5 carbon atoms or an alkenyl group having 2 to 5 carbon atoms, and one —Ch₂— or two or more —CH₂—, which are not adjacent to each other, present in the group may be each independently substituted with —O— or —S—. Further, one hydrogen atoms or two or more hydrogen atoms present in the group may be each independently substituted with a fluorine atom.

When the liquid crystal composition contains a dielectrically neutral compound, without adversely affecting the dielectric anisotropy (Δε) of the composition, other physical properties, for example, the nematic phase-isotropic liquid phase transition temperature (T_{NI}), liquid-crystal phase temperature range, phase transition temperature viscosity (η), rotational viscosity (γ1), and refractive index anisotropy (Δn) of the composition can be controlled to fall in the respective preferred ranges. Such a compound is preferably, for example, a compound represented by the following general formula (N3).

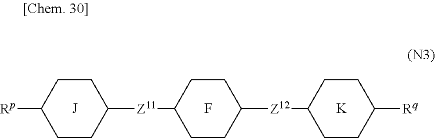

Each of R^{p} and R^{q} is independently preferably an alkyl group having 1 to 10 carbon atoms or an alkenyl group having 2 to 10 carbon atoms (including ones in which one —CH₂— or two or more —CH₂—, which are not adjacent to each other, present: in the group are substituted with —O— or —S—, and ones in which one hydrogen acorn or two or more hydrogen atoms present in the group are substituted with a fluorine atom or a chlorine atom), more preferably an alkyl group having 1 to 5 carbon atoms, an alkoxy group having 1 to 5 carbon atoms, an alkenyl group having 2 to 5 carbon atoms, or an alkenyloxy group having 3 to 6 carbon atoms, especially preferably an alkyl group having 1 to 5 carbon atoms or an alkoxy group having 1 to 5 carbon atoms. R^{p} and R^{q} are further preferably linear, but are not the compound represented by the general formula (I-n). When R^{p} and R^{q} represent an alkenyl group, as the alkenyl group, substituents represented by the following formulae (Alkenyl-2) to (Alkenyl-4) are preferred:

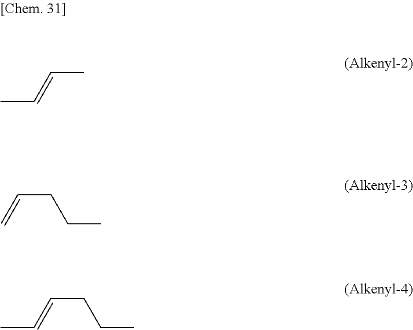

wherein the alkenyl is bonded at the right end thereof to the ring structure.

Each of ring J, ring F and ring K is independently preferably a trans-1,4-cyclohexylene group (including ones in which one —CH₂— or two —CH₂—, which are not adjacent to each other, present in the group are substituted with —O—), a 1,4-phenylene group (including ones in which one —CH═ or two or more —CH═, which are not adjacent to each other, present in the group are substituted with —N═), a 3-fluoro-1,4-phenylene group, a 3,5-difluoro-1,4-phenylene group, a 1,4-cyclohexenylene group, a 1,4-bicyclo[2.2.2]octylene group, a piperidine-1,4-diyl group, a naphthalene-2,6-diyl group, a decahydronaphthalene-2,6-diyl group, or a 1,2,3,4-tetrahydronaphthalene-2,6-diyl group, more preferably a trans-1,4-cyclohexylene group, a 1,4-phenylene group, or a 1,4-bicyclo[2.2.2]octylene group, especially preferably a trans-1,4-cyclohexylene group or a 1,4-phenylene group, o is preferably 0, 1, or 2, more preferably 0 or 1.

Each of Z¹¹ and Z¹² independently represents —OCH₂—, —CH₂O—, —CF₂O—, —OCF₂—, —CH₂CH₂—, —CF₂CF₂— or a single bond, preferably represents —CH₂O—, —CF₂O— or a single bond, further preferably represents —CH₂O— or a single bond.

More specifically, specific structures of the general formula (N3) above are preferably compounds represented by the group consisting of the following general formulae (N3-1) to (N3-9).

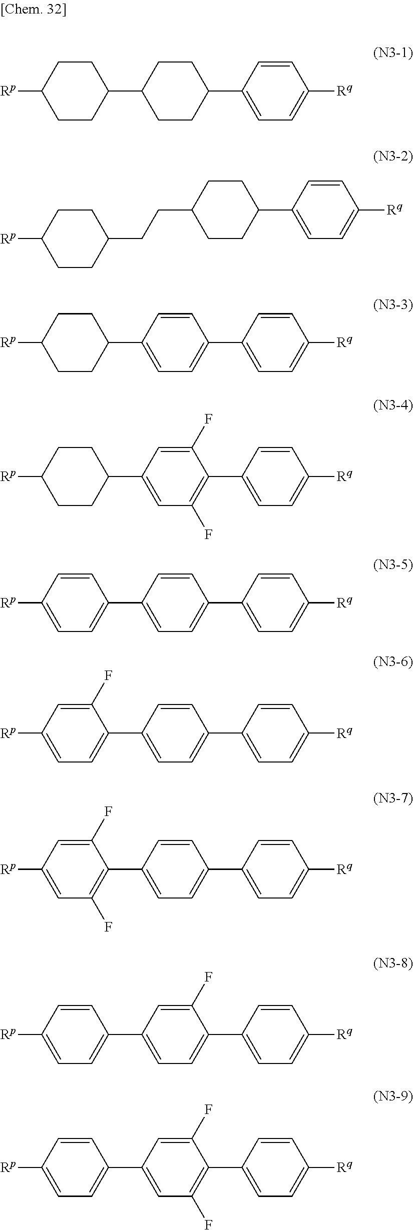

In the general formulae (N3-1) to (N3-9) above, each of R^{p} and R^{q} independently represents an alkyl group having 1 to 10 carbon atoms, an alkoxy group having 1 to 10 carbon atoms, an alkenyl group having 2 to 10 carbon atoms, or an alkenyloxy group having 3 to 10 carbon atoms, excluding the compound represented by the general formula (I-n).

Each of R^{p} and R^{q} is independently more preferably an alkyl group having 1 to 10 carbon atoms, an alkoxy group having 1 to 10 carbon atoms, or an alkenyl group having 2 to 10 carbon atoms, further preferably an alkyl group having 1 to 5 carbon atoms or an alkoxy group having 1 to 10 carbon atoms. R^{p} and R^{q} are further preferably linear.

Among the compounds represented by the general formulae (N3-1) to (N3-9), the compound represented by the general formula (N3-1), (N3-3), (N3-4), (N3-5), (N3-8), or (N3-9) is preferred, and the compound represented by the general formula (N3-1), (N3-3), (N3-5), or (N3-8) is further preferred.

In the present invention, the compound represented by the general formula (N-3) is contained, and, in this case, preferably one kind to 10 kinds, especially preferably 2 to 8 kinds of the compounds are contained, and the lower limit of the content of the compound represented by the general formula (N-3) is preferably 1% by mass, more preferably 3% by mass, especially preferably 5% by mass, and the upper limit of the content is preferably 80% by mass, further preferably 70% by mass, further preferably 60% by mass.

The liquid crystal composition of the invention contains, as a non-polar compound having a Δn which is nearly 0, one kind or two or more kinds of compounds selected from the group consisting of compounds represented by the general formulae (IV-1) to (IV-3), preferably one kind to 10 kinds, further preferably one kind to 5 kinds of the compounds. The total content of the compounds is preferably from 5 to 70% by mass, further preferably from 5 to 50% by mass, especially preferably from 5 to 40% by mass.

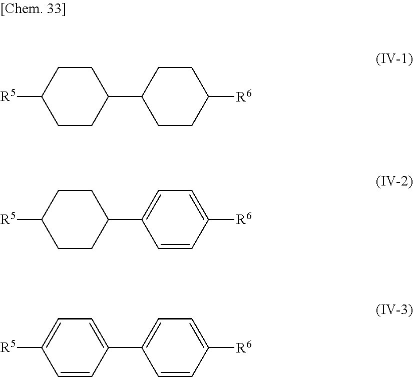

In the above formulae, R⁵ represents an alkyl group having 1 to 5 carbon atoms or an alkenyl group having 2 to 5 carbon atoms, and R⁶ represents an alkyl group having 1 to 5 carbon atoms, an alkoxy group having 1 to 5 carbon atoms, an alkenyl group having 2 to 5 carbon atoms, or an alkenyloxy group having 2 to 5 carbon atoms. One —CH₂— or two or more —CH₂—, which are not adjacent to each other, present in the group may be each independently substituted with —O— or —S—, and one hydrogen atom or two or more hydrogen atoms present in the group may be each independently substituted with a fluorine atom. The compound represented by the general formula (I-n) is excluded.

The liquid crystal composition preferably further contains one kind or two or more kinds of compounds represented by the following general formula (Np-1) or general formula (Np-2).

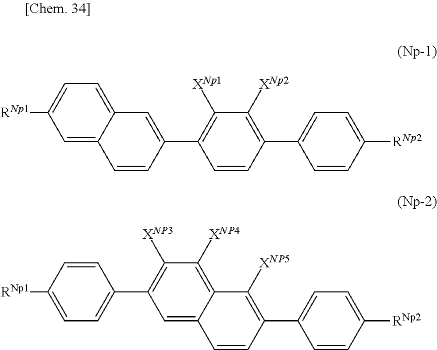

In the above formulae, each of R^{Np1} and R^{Np2} independently represents an alkyl group having 1 to 5 carbon atoms, an alkoxy group having 1 to 5 carbon atoms, an alkenyl group having 2 to 5 carbon atoms, or an alkenyloxy group having 2 to 5 carbon atoms, preferably an alkyl group having 1 to 5 carbon atoms. One —CH₂— or two or more —CH₂—, which are not adjacent to each other, present in the group may be each independently substituted with —O— or —S—, and one hydrogen atom or two or more hydrogen atoms present in the group may be each independently substituted with a fluorine atom.

Each of X^{Np1}, X^{Np2}, X^{Np3}, X^{Np4}, and X^{Np5} independently represents a hydrogen atom or a fluorine atom, and it is preferred that at least one of them is a fluorine atom, and it is further preferred that at least two of them are fluorine atoms.

The liquid crystal composition of the invention contains, as the compound having a 1-propenyl group, preferably one kind or two or more kinds of compounds selected from the general formula (I), and preferably contains one kind or two or more kinds of compounds selected from the general formula (I-n), further preferably contains two or more kinds of compounds selected from the general formula (I) and general formula (I-n), and preferably contains both the compounds represented by the general formula (I) and general formula (I-n).

The liquid crystal composition of the invention preferably contains both the compounds represented by the general formula (I-A1) and general formula (I-n1), preferably contains both the compounds represented by the general formula (I-C1) and general formula (I-n1), preferably contains both the compounds represented by the general formula (I-D1) and general formula (I-n1), preferably contains both the compounds represented by the general formula (I-A2) and general formula (I-n1), and preferably contains both the compounds represented by the general formula (I-C2) and general formula (I-n1).

The liquid crystal composition of the invention preferably contains one kind of a compound selected from the group consisting of compounds represented by the general formula (I) and one kind of a compound selected from the group consisting of compounds represented by the general formula (I-n), and preferably contains two kinds of compounds selected from the group consisting of compounds represented by the general formula (I) and two kinds of compounds selected from the group consisting of compounds represented by the general formula (I-n).

In the liquid crystal composition of the invention, the total content of the above-mentioned preferred compounds is preferably from 85 to 100% by mass, further preferably from 90 to 100% by mass.

As a further component, one kind or two or more kinds of compounds represented by the general formula (V) below are preferably contained, and the content of the compound is preferably from 2 to 30% by mass, further preferably from 2 to 25% by mass, especially preferably from 3 to 20% by mass.

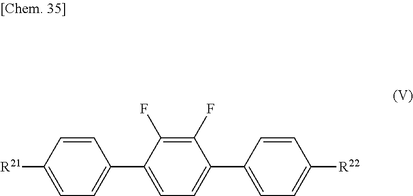

In the above formula, each of R²¹ and R²² independently represents an alkyl group having 1 to 8 carbon atoms, an alkoxy group having 1 to 8 carbon atoms, an alkenyl group having 2 to 8 carbon atoms, or an alkenyloxy group having 2 to 8 carbon atoms, preferably an alkyl group having 1 to 5 carbon atoms or an alkenyl group having 2 to 5 carbon atoms. One —CH₂— or two or more —CH₂—, which are not adjacent to each other, present in the group may be each independently substituted with —O— or —S—, and one hydrogen atom or two or more hydrogen atoms present in the group may be each independently substituted with a fluorine atom.

Each of R²¹ and R²² is independently further preferably an alkyl group having 1 to 3 carbon atoms, especially preferably the formula (V-55).

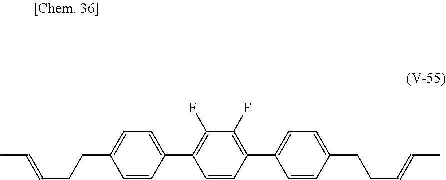 [SMILES: C/C=C/CCc1ccc(-c2ccc(-c3ccc(CC/C=C/C)cc3)c(F)c2F)cc1]

The total content of the compounds represented by the general formula (I), general formula (I-n), general formula (N3), general formula (II), general formulae (IV-1) to (IV-3), and general formula (V) in the non-polymerizable low-molecular compound in the liquid crystal composition is preferably 80% or more, preferably 85% or more, preferably 88% or more, preferably 90% or more, preferably 92% or more, preferably 94% or more, preferably 95% or more, preferably 97% or more, preferably 98% or more, preferably 99% or more, and it is preferred that other components are substantially not contained. Here the “substantially” means that only the compounds represented by the general formula (I), general formula (I-n), general formula (N3), general formula (II), general formulae (IV-1) to (IV-3), and general formula (V), except the compounds inevitably mixed in the production step, are contained.

A's in the general formula (I) and general formula (II) maybe the same or different, Z¹¹'s in the general formula (I), general formula (I-n), general formula (N3), and general formula (II) may be the same or different, Z¹²'s in the general formula (I), general formula (I-n), and general formula (N3) may be the same or different, and R^{q}'s in the general formula (I-n) and general formula (N3) may be the same or different.

The liquid crystal composition of the invention has a dielectric anisotropy (Δε) at 25° C. of from −2.0 to −8.0, preferably from −2.0 to −6.0, more preferably from −2.0 to −5.0, especially preferably from −2.5 to −4.0.

The liquid crystal composition of the invention has a refractive index anisotropy (Δn) at 20° C. of from 0.08 to 0.14, more preferably from 0.09 to 0.13, especially preferably from 0.09 to 0.12. More specifically, when applying the composition to a small cell gap, the refractive index anisotropy is preferably from 0.10 to 0.13, and, when applying the composition to a large cell gap, the refractive index anisotropy is preferably from 0.08 to 0.10.

The liquid crystal composition of the invention has a viscosity (η) at 20° C. of from 10 to 30 mPa·s, more preferably from 10 to 25 mPa·s, especially preferably from 10 to 22 mPa·s.

The liquid crystal composition of the invention has a rotational viscosity (γ1) at 20° C. of from 60 to 130 mPa·s, more preferably from 60 to 110 mPa·s, especially preferably from 60 to 100 mPa·s.

The liquid crystal composition of the invention has a nematic phase-isotropic liquid phase transition temperature (Tₙᵢ) of from 60 to 120° C., more preferably from 70 to 100° C., especially preferably from 70 to 85° C.

The liquid crystal composition of the invention may contain, in addition to the above-mentioned compounds, a general nematic liquid crystal, a smectic liquid crystal, a cholesteric liquid crystal, an antioxidant, an ultraviolet light absorber, a polymerizable monomer, or the like.

For example, as a polymerizable monomer, a polymerizable compound, such as a biphenyl derivative or a terphenyl derivative, is preferably contained. More specifically, the liquid crystal composition of the invention preferably contains one kind or two or more kinds of polymerizable compounds represented by the following general formula (RM-1).

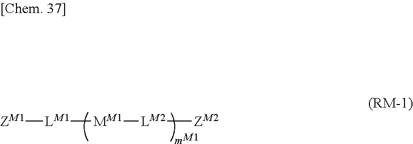

In the above formula, each of Z^{M1} and Z^{M2} independently represents the following:

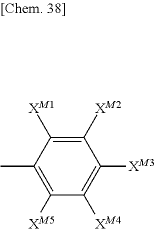

wherein X^{M1} to X^{M5} represent hydrogen, fluorine, or the following:

-S^{M1}-R^{M1}, and [Chem. 39]

with respect to at least one of X^{M1} to X^{M5} in Z^{M1} and Z^{M2}, the following:

-S^{M1}-R^{M1} [Chem. 40]

is preferred.

S^{M1} represents an alkyl group having 1 to 12 carbon atoms or a single bond, and a methylene group in the alkyl group may be substituted with an oxygen atom, —COO—, —OCO—, or —OCOO— so that oxygen atoms are not directly bonded to each other.

R^{M1} represents any of the following formulae (R-1) to (R-15):

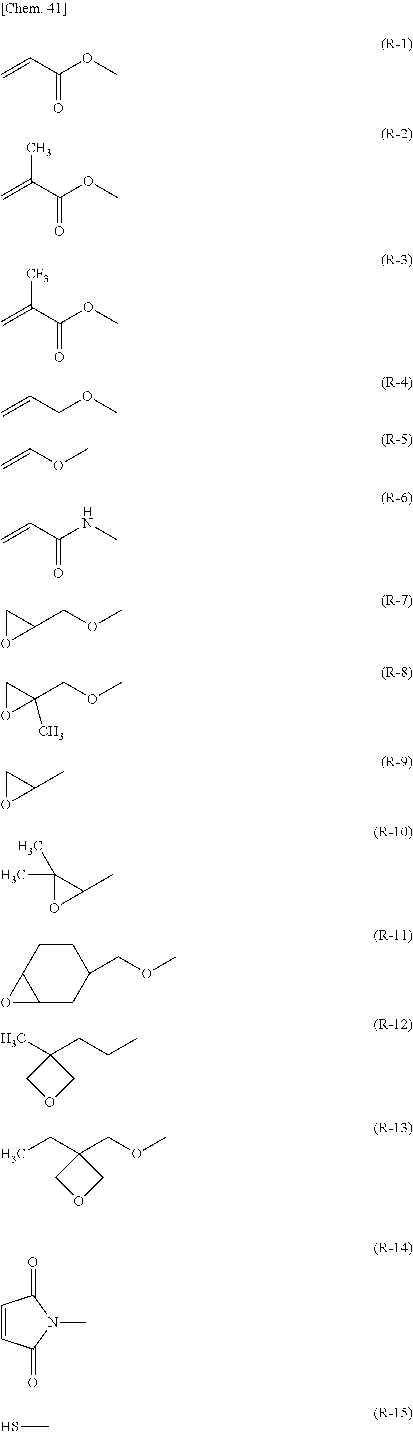

preferably represents the formula (R-1) or the formula (R-2).

Each of L^{M1} and L^{M2} independently represents a single bond, —O—, —CH₂—, —OCH₂—, —CH₂O—, —CO—, —C₂H₄—, —COO—, —OCO—, —CH═CH—COO—, —COO—CH═CH—, —OCO—CH═CH—, —CH═CH—OCO—, —COOC₂H₄—, —OCOC₂H₄—, —C₂H₄OCO—, —C₂H₄COO—, —OCOCH₂—, —CH₂COO—, —CH═CH—, —CF═CH—, —CH═CF—, —CF═CF—, —CF₂—, —CF₂O—, —OCF₂—, —CF₂CH₂—, —CH₂CF₂—, —CF₂CF₂— or —C≡C—, and when plural L^{M2}'s are present, they may be the same or different, preferably represents a single bond, —OCH₂—, —CH₂O—, —C₂H₄—, —COO—, —OCO—, —CH═CH—COO—, —COO—CH═CH—, —OCO—CH═CH—, —CH═CH—OCO—, —COOC₂H₄—, —OCOC₂H₄—, —C₂H₄OCO—, —C₂H₄COO—, —CF₂O—, —OCF₂—, OR —C≡C—, more preferably a single bond, —C₂H₄—, —COO—, —OCO—, —CH═CH—COO—, —COO—CH═CH—, —OCO—CH═CH—, —CH═CH—OCO—, —COOC₂H₄—, —OCOC₂H₄—, or —C₂H₄COO—.

M^{M1} each occurrence independently represents a 1,4-phenylene group, a 1,4-cyclohexylene group, or a naphthalene-2,6-diyl group, and M^{M1} is each independently unsubstituted or a hydrogen atom contained in the group may be substituted with a fluorine atom, a chlorine atom, an alkyl group, a halogenated alkyl group, a halogenated alkoxy group or an alkoxy group, each having 1 to 8 carbon atoms, a nitro group, or the following:

-S^{M1}-R^{M1}, and [Chem. 42]

when plural M^{M1}'s are present, they may be the same or different. M^{M1} is preferably a 1,4-phenylene group, which is unsubstituted or in which a hydrogen atom contained in the group is substituted with a fluorine atom, an alkyl group having 1 to 8 carbon atoms or an alkoxy group having 1 to 8 carbon atoms. In this case, when plural M^{M1}'s are present, they may be the same or different.

m^{M1} represents 0, 1, or 2, preferably 0 or 1.

More specifically, as the compound represented by the general formula (RM-1) which is a polymerizable compound, specifically, there can be mentioned a compound represented by the following general formula (RM-1A).

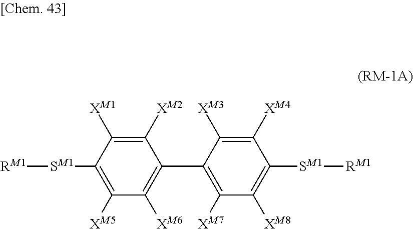

wherein R^{M1} and S^{M1}, respectively, have the same meanings as those of R^{M1} and S^{M1} in the general formula (RM-1A), and X^{M1} to X^{M8} represent hydrogen, fluorine, or the following:

-S^{M1}-R^{M1}. [Chem. 44]

In the compound represented by the general formula (RM-1A), the structure of the above-mentioned biphenyl skeleton is preferably unsubstituted or the formulae (IV-11) to (IV-14), preferably unsubstituted or the formula (IV-11).

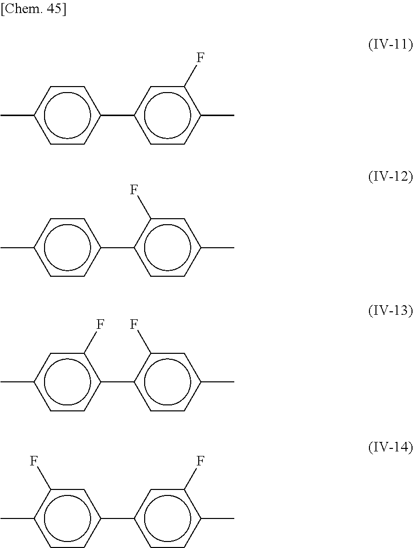

The polymerizable compound containing a biphenyl skeleton which is unsubstituted or represented by the formulae (IV-11) to (IV-14) has an optimal orientation control ability after being polymerized, and achieves excellent orientation state.

Further, as the compound represented by the general formula (RM-1), there can be mentioned a compound represented by the following general formula (RM-1B):

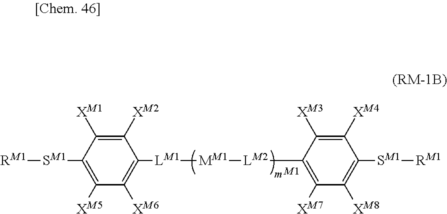

wherein R^{M1}, S^{M1}, L^{M1}, L^{M2}, M^{M1}, and m^{M1}, respectively, have the same meanings as those of R^{M1}, S^{M1}, L^{M1}, L^{M2}, M^{M1}, and m^{M1} in the general formula (RM-1), and X^{M1} to X^{M5} represent hydrogen, fluorine, or the following:

-S^{M1}-R^{M1}. [Chem. 47]

As the compound represented by the general formula (RM-1), which is a polymerizable compound, specifically, preferred are compounds represented by the following structural formulae (M1-1) to (M1-13), (M2-1) to (M2-8), (M3-1) to (M3-6), (M4-1) to (M4-7), and (I-1) to (I-40).

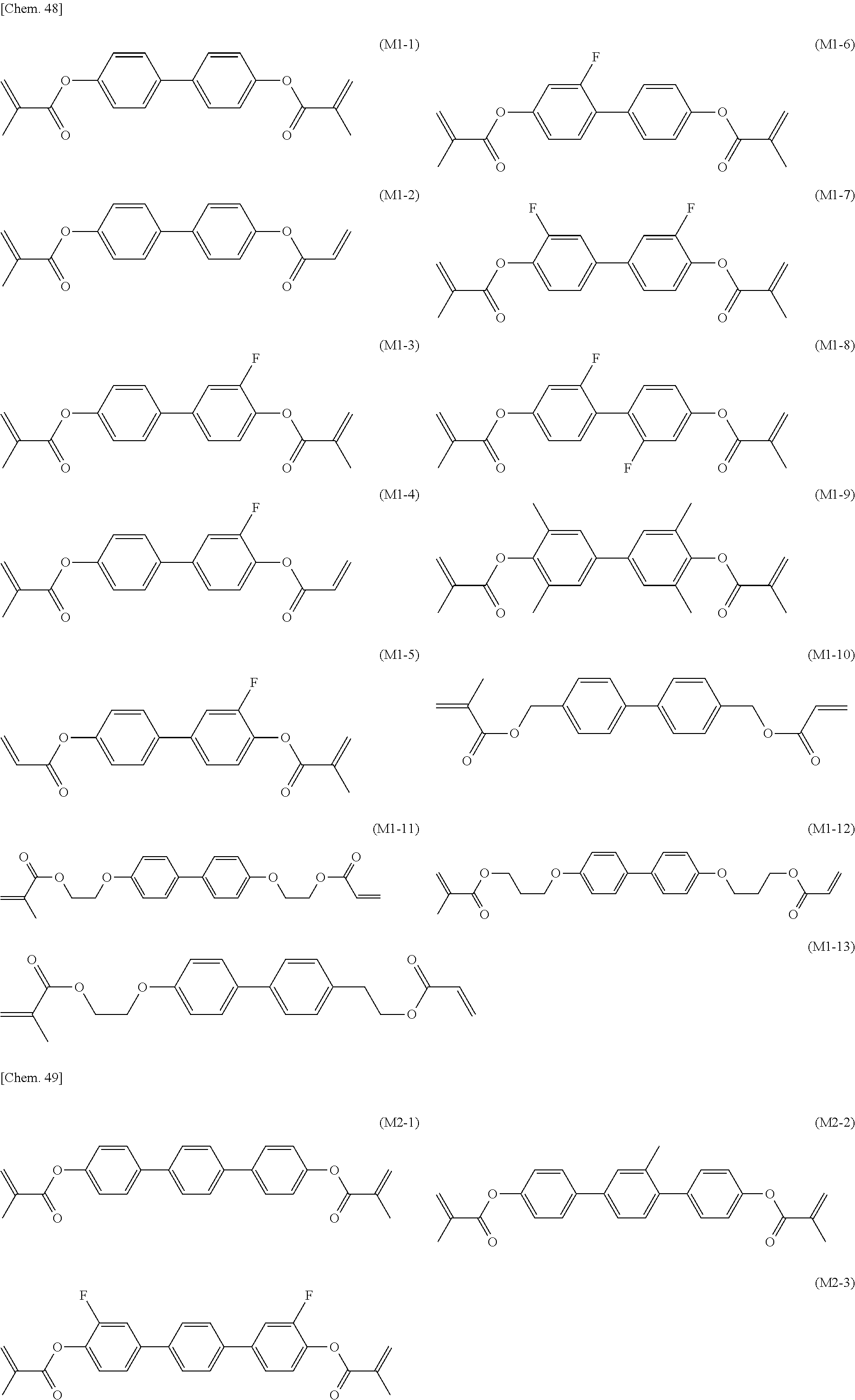

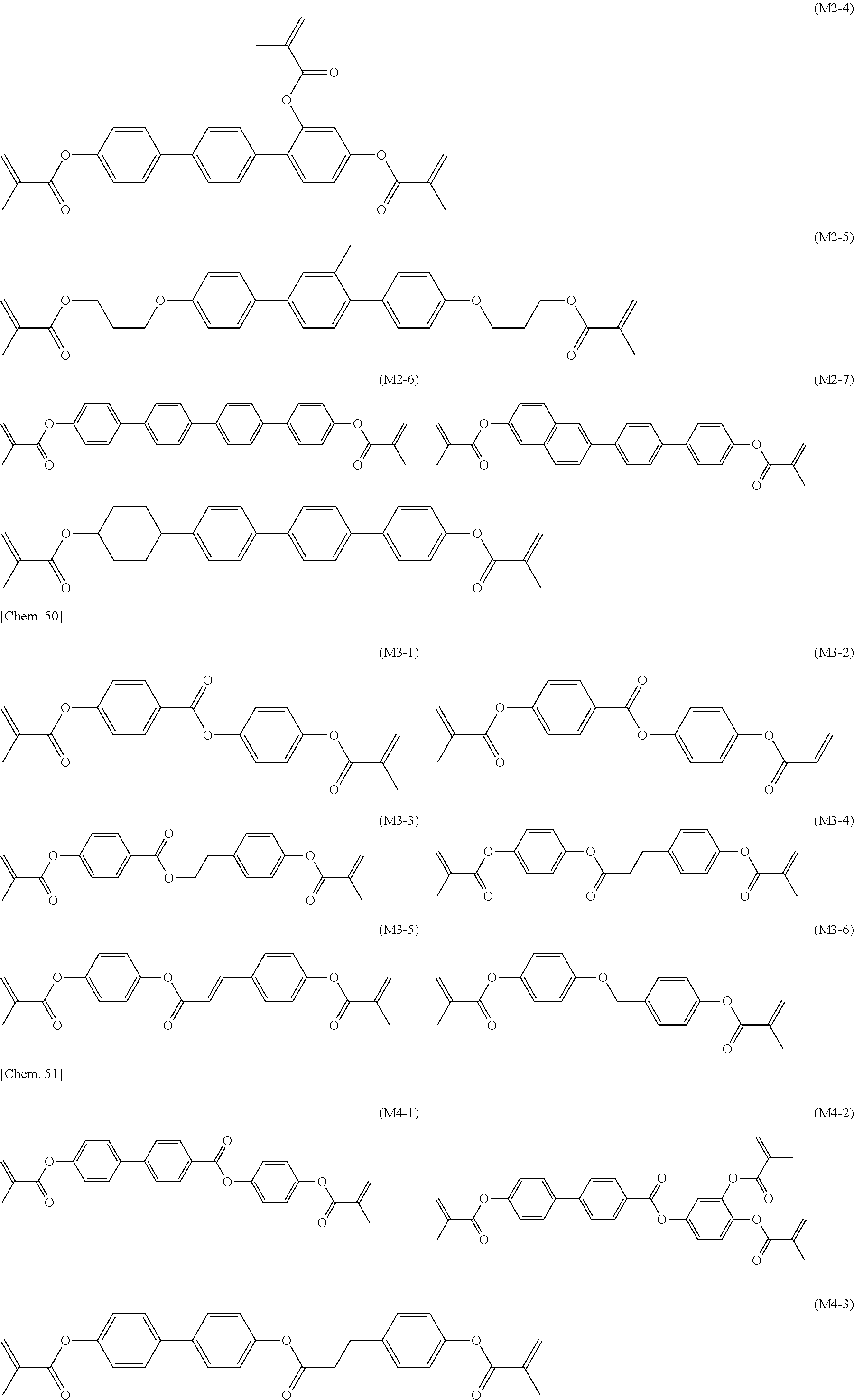

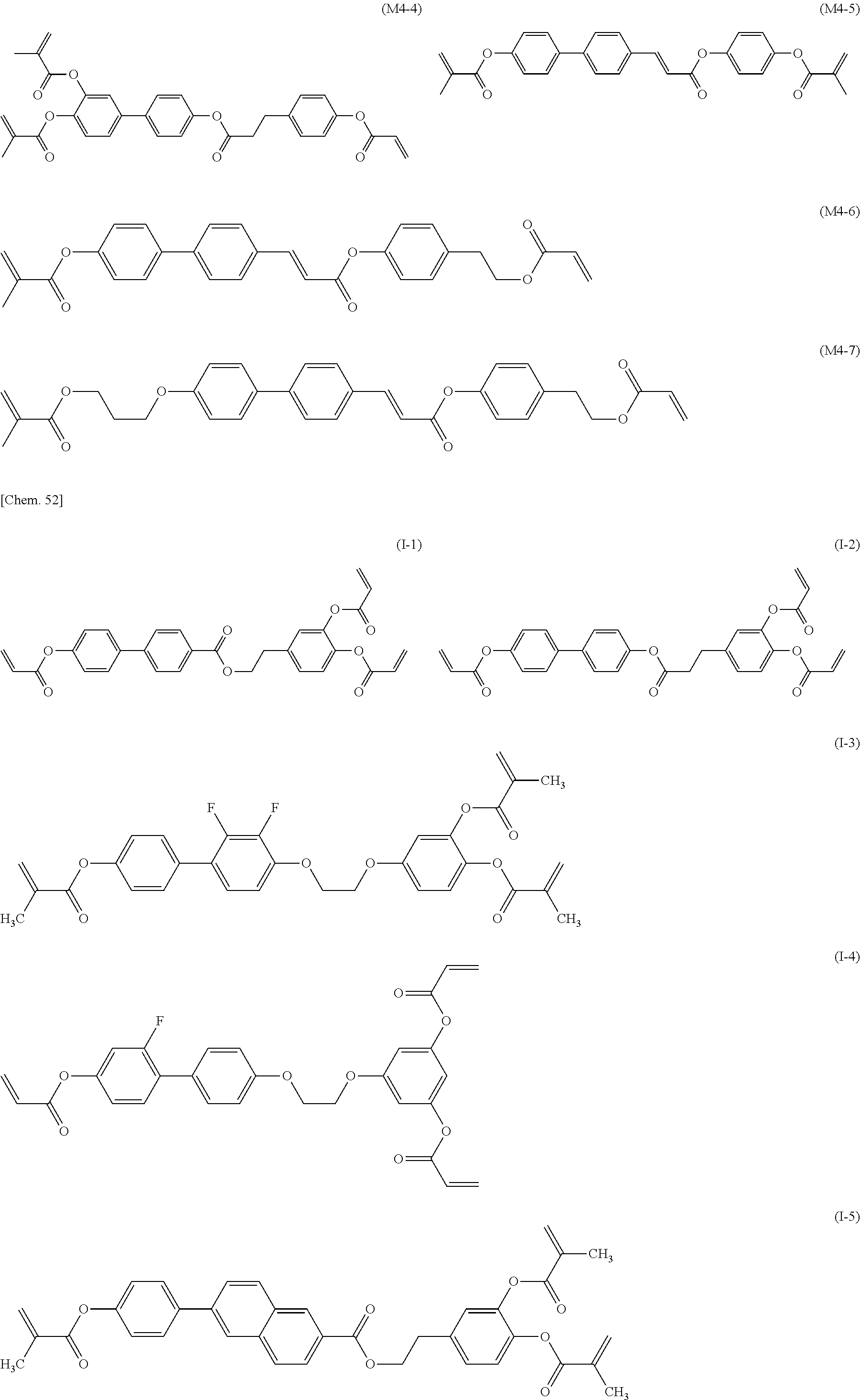

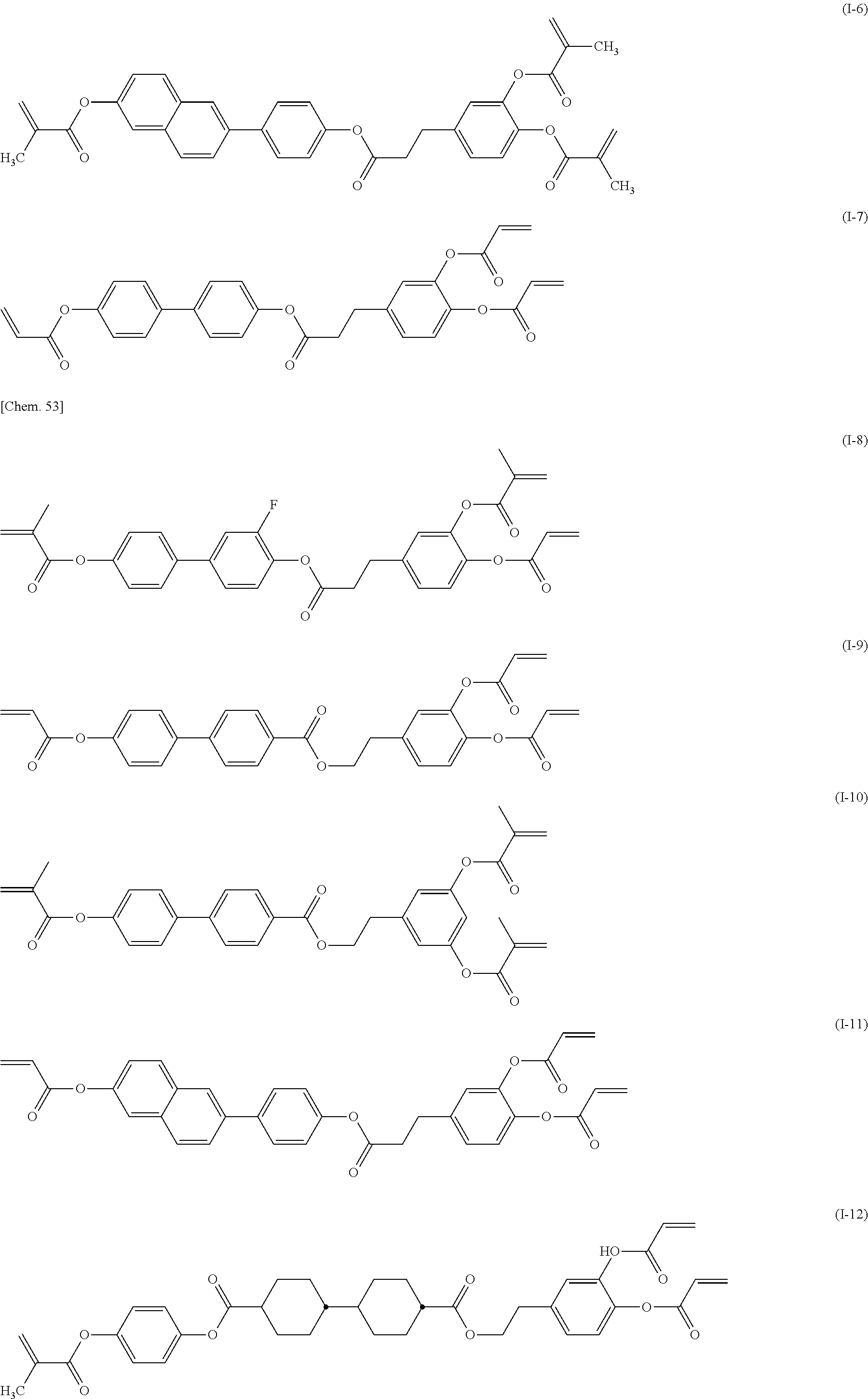

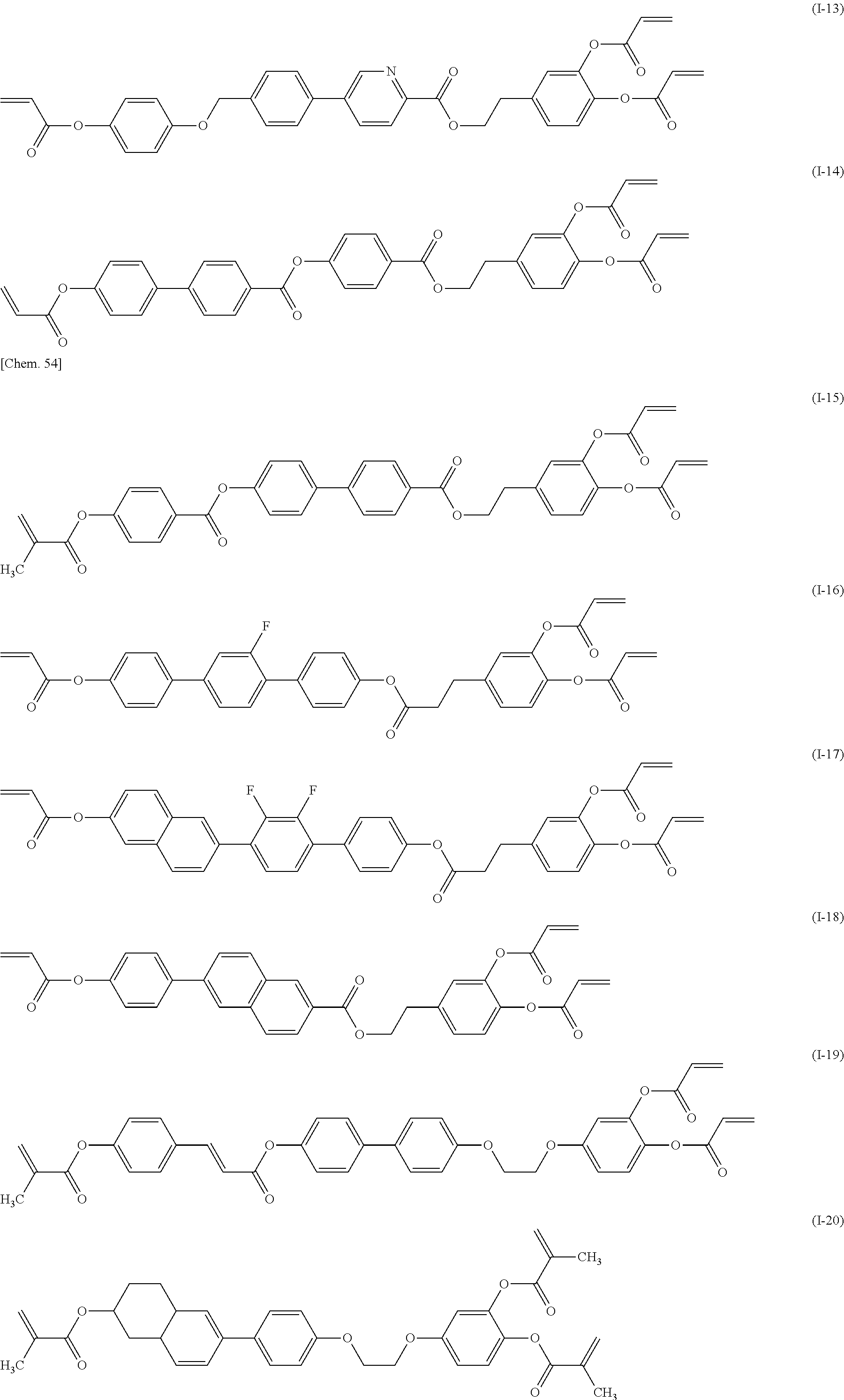

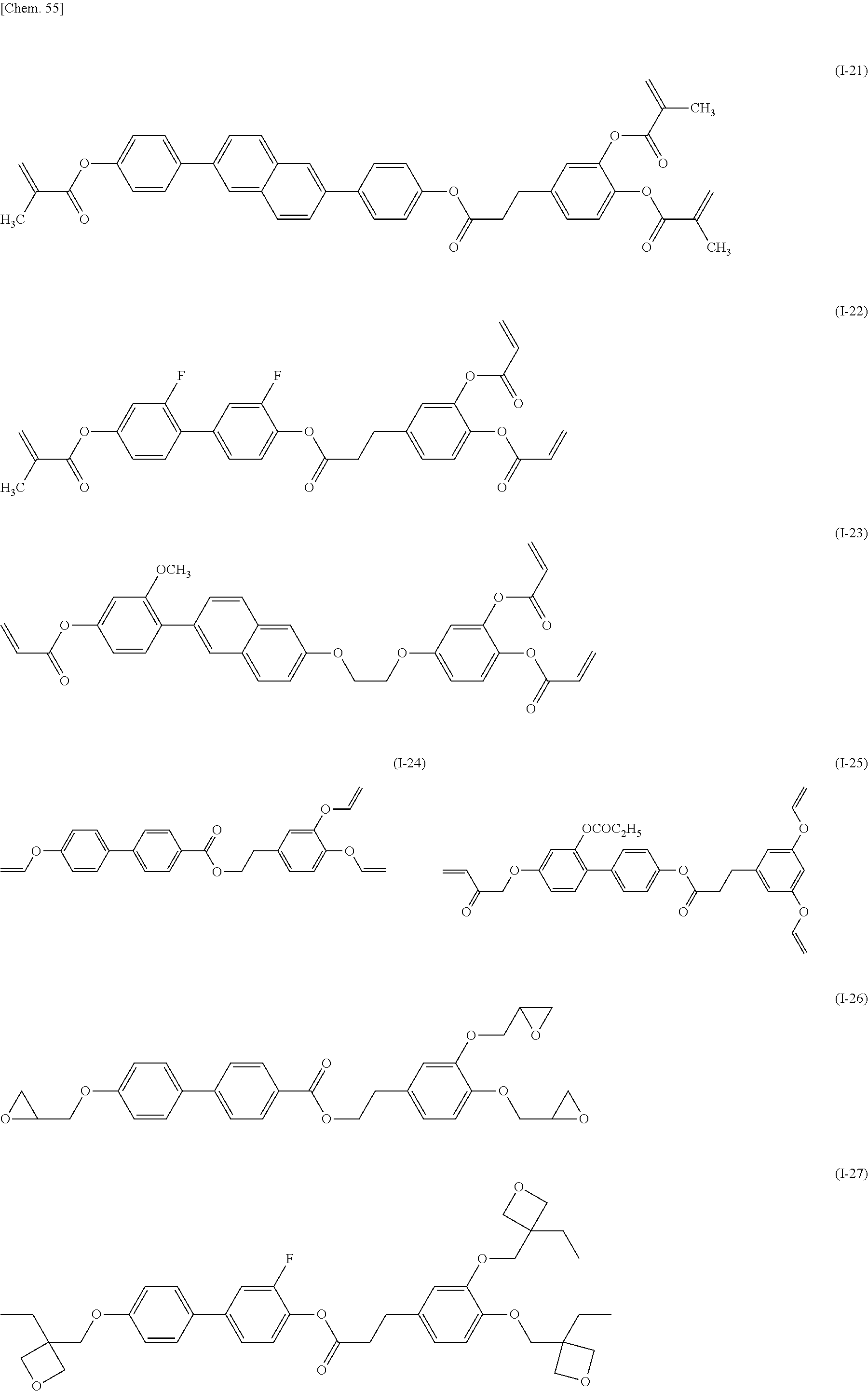

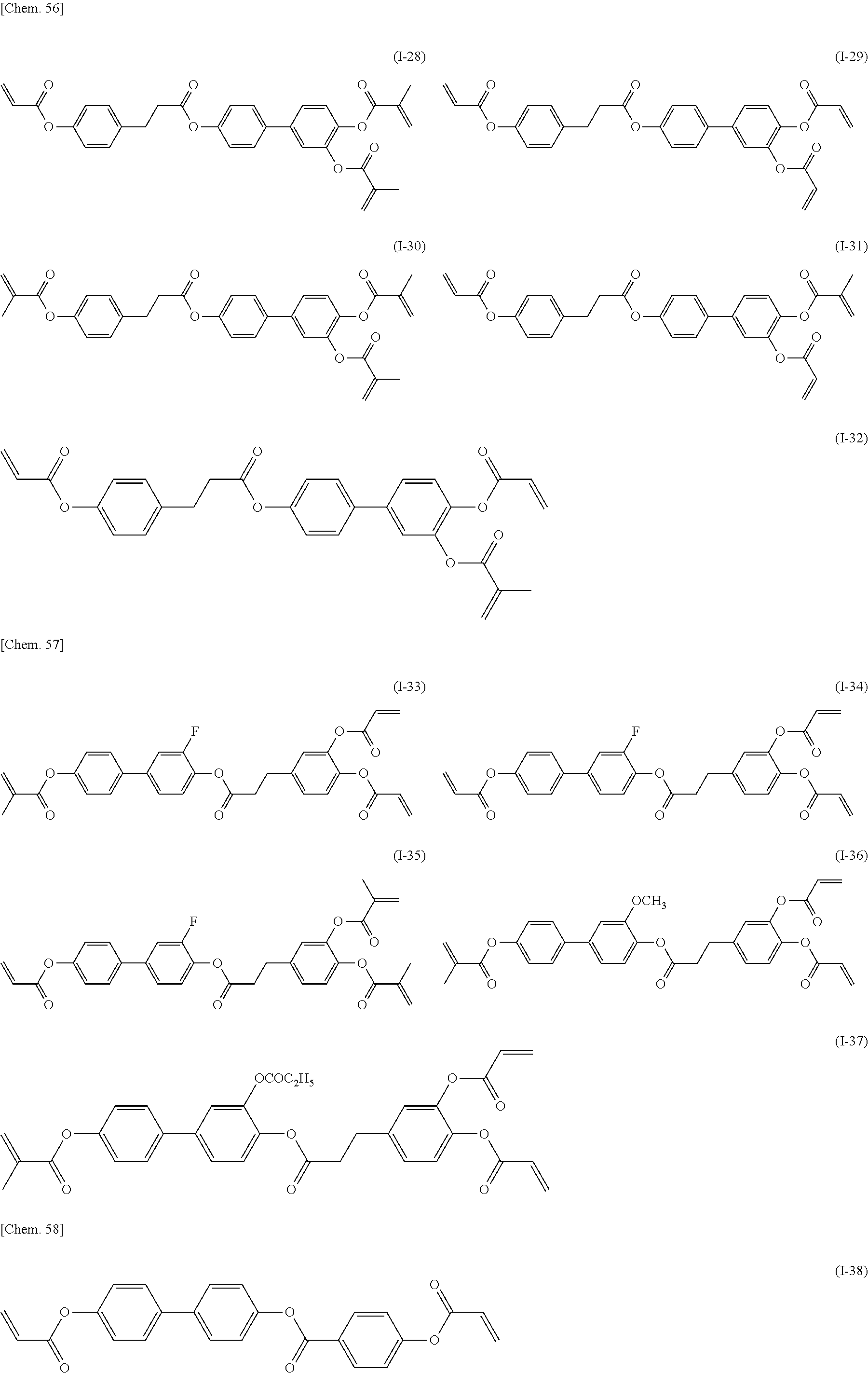

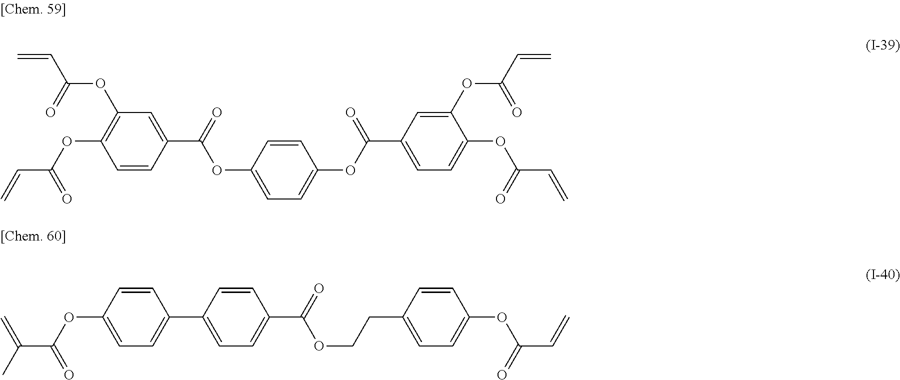

Further preferred are compounds represented by (M1-1) to (M1-8), (M1-10) to (M1-13), (M2-2) to (M2-5), (M3-1), (M3-4), (M3-5), (M4-1), (M4-2), (M4-4), (M4-6), (M4-7), (I-1) to (I-11), (I-22) to (I-25), and (I-28) to (I-40), and especially preferred are compounds represented by (M1-1), (M1-3) (M1-6) to (M1-8), (M1-11), (M1-12), (M2-2), (M2-4), (M3-1), (M3-5), (M4-2), (M4-6), (M4-7), and (I-33) to (I-37).

The polymerizable compound-containing liquid crystal composition of the invention, which contains both the compound of the general formula (I) and/or general formula (1-n) and the compound of the general formula (RM-1) which is a polymerizable compound, achieves a low viscosity (η), a low rotational viscosity (γ1), a large elastic constant (K₃₃), and a high VHR, and therefore a liquid crystal display element of a PSA mode or a PSVA mode using the composition can realize both high-speed response and high reliability. The liquid crystal composition preferably contains all the compounds of the general formula (I) and general formula (I-n) and the compound of the general formula (RM-1) which is a polymerizable compound, further preferably contains all the compounds of the general formula (I), general formula (I-n), and general formula (N-3) and the compound of the general formula (RM-1) which is a polymerizable compound, further preferably contains all the compounds of the general formula (I), general formula (I-n), general formula (N-3), and general formula (II) and the compound of the general formula (RM-1) which is a polymerizable compound, further preferably contains both a compound selected from the group consisting of the general formula (I), general formula (I-n), general formula (N-3), general formula (II), and general formulae (IV-1) and (IV-2) and the compound of the general formula (RM-1) which is a polymerizable compound, and further preferably contains all a compound selected from the group consisting of the general formula (I), general formula (I-n), general formula (N-3), general formula (II), and general formulae (IV-1) and (IV-2), the compound of the general formula (V), and the compound of the general formula (RM-1) which is a polymerizable compound.

With respect to the content of the polymerizable monomer in the liquid crystal composition, the upper limit is preferably 5% by mass, preferably 3% by mass, preferably 2% by mass, preferably 1% by mass, preferably 0.8% by mass, preferably 0.5% by mass, preferably 0.4% by mass, preferably 0.3% by mass, preferably 0.2% by mass, and the lower limit is preferably 0.01% by mass, preferably 0.05% by mass, preferably 0.1% by mass, preferably 0.2% by mass, preferably 0.3% by mass.

The liquid crystal composition of the invention may further contain a compound represented by the following general formula (Q).

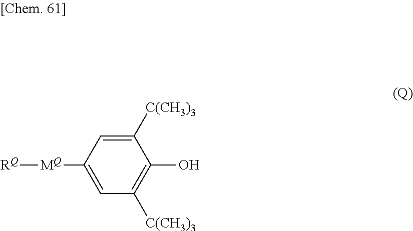

In the above formula, R^{Q} represents a linear alkyl group or branched alkyl group having 1 to 22 carbon atoms, and one CH₂ group or two or more CH₂ groups, which are not adjacent to each other, in the group may be substituted with —O—, —CH═CH—, —CO—, 'OCO—, —COO—, —C≡C—, —CF₂O—, or —OCF₂—.

M^{Q} represents a trans-1,4-cyclohexylene group, a 1,4-phenylene group or a single bond.

As the compound represented by the general formula (Q), specifically, preferred, are compounds represented by the following general formulae (Q-a) to (Q-e).

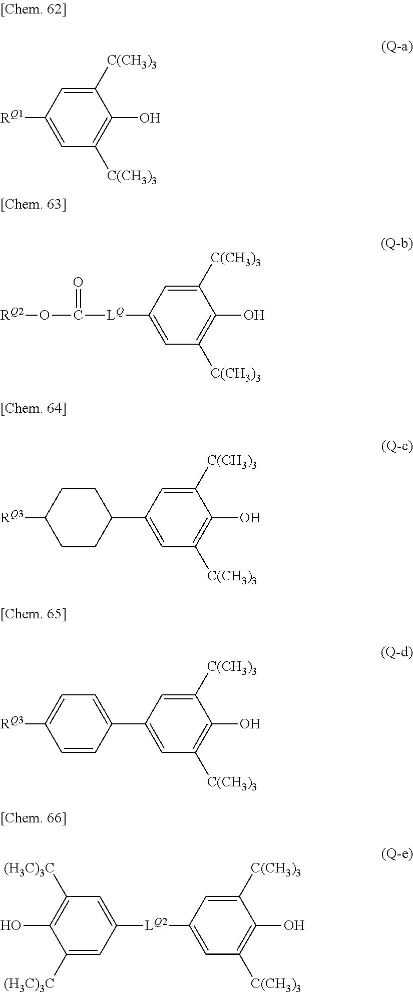

In the above formulae, R^{Q1} is preferably a linear alkyl group or branched alkyl group having 1 to 10 carbon atoms.

R^{Q2} is preferably a linear alkyl group or branched alkyl group having 1 to 20 carbon atoms.

R^{Q3} is preferably a linear alkyl group, branched alkyl group, linear alkoxy group, or branched alkoxy group having 1 to 8 carbon atoms.

L^{Q} is preferably a linear alkylene group or branched alkylene group having 1 to 8 carbon atoms.

L^{Q2} is preferably a linear alkylene group or branched alkylene group having 2 to 12 carbon atoms.

Among the compounds represented by the general formulae (Q-a) to (Q-e), the compounds represented by the general formula (Q-c), general formula (Q-d), and general formula (Q-e) are further preferred.

The liquid crystal composition of the invention may contain one kind or two or more kinds of the compounds represented by the general formula (Q), but contains preferably one Kind to 5 kinds, further preferably one kind to 3 kinds, especially preferably one kind of the compound. The content of the compound in the composition is preferably from 0.001 to 1% by mass, further preferably from 0.001 to 0.1% by mass, especially preferably from 0.001 to 0.05% by mass. The polymerizable compound-containing liquid crystal composition, which contains both the liquid crystal composition of the invention and the compound of the general formula (RM-1) which is a polymerizable compound, achieves a low viscosity (η), a low rotational viscosity (γ₁), a large elastic constant (K₃₃), and a high VHR, and therefore a liquid crystal display element of a PSA mode or a PSVA mode using the composition can realize both high-speed response and high reliability.

The liquid crystal display element using the liquid crystal composition of the invention has such a remarkable feature that the response speed is high, and is particularly useful as a liquid crystal display element for active matrix driving, and can be applied to ones for a VA mode, a PSVA mode, a PSA mode, an IPS mode, or an ECB mode.

### Examples

Hereinbelow, the present invention will be described in more detail with reference to the following Examples, which should not be construed as limiting the scope of the invention.

In the following Examples and Comparative Examples, “%” used for the composition means “% by mass”.

In the Examples, the following abbreviations for the compounds are used.

### (Side Chains)

-n —CₙH₂ₙ₊₁ Linear alkyl group having n carbon atom(s)
n- CₙH₂ₙ₊₁— Linear alkyl group having n carbon atom(s)
—On —OCₙH₂ₙ₊₁ Linear alkoxy group having n carbon atom(s)
nO— CₙH₂ₙ₊₁O— Linear alkoxy group having n carbon atom(s)
—V —CH═CH₂
V— CH₂═CH—
—V1 —CH═CH—CH₃
1V— CH₃—CH═CH—
-2V —CH₂—CH₂—CH═CH₃
V2- CH₃═CH—CH₂—CH₂—
-2V1 —CH₂—CH₂—CH═CH—CH₃
1V2— CH₃—CH═Ch—CH₂—CH₂

### (Ring Structures)

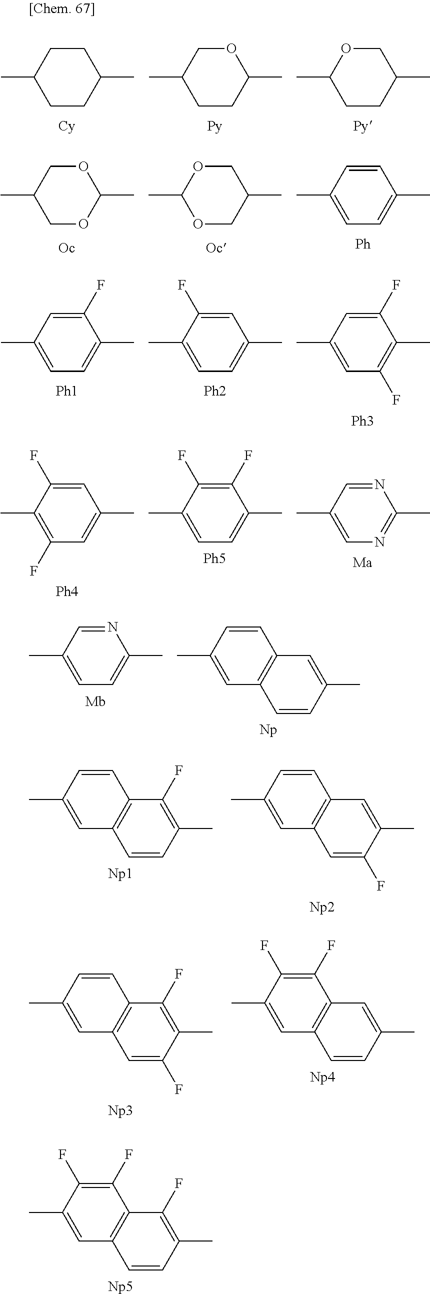

The properties measured in the Examples are as follows.

Tₙᵢ: Nematic phase-isotropic liquid phase transition temperature (° C.)

Tₒₙ: Solid phase-nematic phase transition temperature (° C.)

Δn: Refractive index anisotropy at 20° C.

Δε: Dielectric anisotropy at 20° C.

η: Viscosity (mPa·s) at 20° C.

γ₁: Rotational viscosity (mPa·s) at 20° C.

K₃₃: Elastic constant K₃₃ (pN) at 20° C.

VHR: Voltage holding ratio (%) after irradiation with UV at 60 J

### Comparative Example 1, Comparative Example 2, Example 1, Example 2, and Example 3

Liquid crystal compositions LC-A (Comparative Example 1), LC-B (Comparative Example 2), LC-1 (Example 1), LC-2 (Example 2), and LC-3 (Example 3) were prepared, and physical properties of the prepared compositions were measured. The constituents of the liquid crystal compositions and the results of the measurement of physical properties are shown in Table 1.

TABLE 1

| | Comparative | Comparative | | | | | |
|---|---|---|---|---|---|---|---|
| | Example 1 | Example 2 | Example 1 | Example 2 | Example 3 | Example 4 | Example 5 |
| | LC-A | LC-B | LC-1 | LC-2 | LC-3 | LC-4 | LC-5 |
| 1V-Cy-1O-Ph5-O2 General formula (I) | | | 8 | 13 | 13 | 13 | 5 |
| 1V-Cy-1O-Ph5-O4 General formula (I) | | | | | | | 5 |
| 1V-Cy-Cy-1O-Ph5-O2 General formula (I) | | | 10 | 13 | 13 | 13 | 9 |
| 1V-Cy-Cy-1O-Ph5-O3 General formula (I) | | | | | | | 8 |
| 2-Cy-Cy-V1 General formula (I-n) | | | 11.7 | 20 | 20 | 20 | |
| 3-Cy-Cy-V1 General formula (I-n) | | | 8 | 10 | 10 | 10 | |
| 1V-Cy-Cy-Ph-1 General formula (I-n) | | | | | | 2 | |
| 1V-Cy-Ph-Ph-3 General formula (I-n) | | | | | | 2 | 5 |
| 3-Cy-Cy-V General formula (IV-1) | | 39 | 10 | | | | |
| 3-Cy-1O-Ph5-O1 General formula (II) | | | | | 1 | | |
| 3-Cy-1O-Ph5-O2 General formula (II) | 11 | 9 | 9 | 3 | 2 | 3 | 4 |
| 2-Cy-Cy-1O-Ph5-O2 General formula (II) | 6 | 12.7 | 4.5 | 3 | 3 | | |
| 3-Cy-Cy-1O-Ph5-O2 General formula (II) | 11 | 13 | 5 | 10 | 10 | 13 | |
| 4-Cy-Cy-1O-Ph5-O2 General formula (II) | | 3 | | | | | |
| V-Cy-Cy-1O-Ph5-O2 General formula (II) | | | 5 | | | | |
| 3-Np-Ph5-Ph-2 General formula (Np-1) | | | 2 | 2 | 2 | 2 | 3 |
| 2-Cy-Ph-Ph5-O2 General formula (II-B4) | | | | | | | 7 |
| 3-Cy-Ph-Ph5-O2 General formula (II-B4) | 7 | | | | | | 8 |
| 3-Cy-Ph-Ph5-O3 General formula (II-B4) | 8 | | | | | | |
| 3-Cy-Ph-Ph5-O4 General formula (II-B4) | 6 | | | | | | |
| 3-Cy-Cy-2 General formula (IV-1) | 17.7 | | | 2.7 | 2.7 | 2.7 | 19.65 |
| 3-Cy-Cy-4 General formula (IV-1) | 8 | | | | | | 8 |
| 3-Cy-Cy-5 General formula (IV-1) | | | | | | | 5 |
| 3-Cy-Ph-O1 General formula (IV-2) | 4 | | | | | | 4 |
| 3-Ph-Ph-1 General formula (IV-3) | 11 | 5 | | 12 | 12 | 12 | 9 |
| 5-Ph-Ph-1 General formula (IV-3) | | | 12 | | | | |
| 3-Cy-Cy-Ph-1 General formula (N3-1) | 5 | | 3.5 | | | | |
| 3-Cy-Ph-Ph-2 General formula (N3-3) | | | 6 | 6 | 6 | 4 | |
| 5-Cy-Ph-Ph-2 General formula (N3-3) | | | 5 | 5 | 5 | | |
| 3-Ph-Ph5-Ph-1 General formula (V) | | 9 | | | | | |
| 3-Ph-Ph5-Ph-2 General formula (V) | 5 | 9 | | | | | |
| 1V2-Ph-Ph5-Ph-2V1 General formula (V) | | | | | | 3 | |
| Polymerizable | 0.3 | 0.3 | 0.3 | 0.3 | 0.2 | | |
| compound Formula (M1-3) | | | | | | | |
| Polymerizable | | | | | 0.1 | | |
| compound Formula (M4-7) | | | | | | | |
| Polymerizable | | | | | | 0.3 | 0.35 |
| compound Formula (I-33) | | | | | | | |
| Total | 100 | 100 | 100 | 100 | 100 | 100 | 100 |
| Tni [° C.] | 75 | 75 | 75 | 75 | 75 | 75 | 76 |
| Tcn [° C.] | −32 | −54 | −59 | −55 | −55 | −48 | −27 |
| Δn | 0.108 | 0.107 | 0.108 | 0.109 | 0.109 | 0.110 | 0.109 |
| γ₁ [mPa · s] | 129 | 96 | 103 | 110 | 110 | 113 | 119 |
| Δε | −3.0 | −3.1 | −3.0 | −3.0 | −3.0 | −3.1 | −3.0 |
| K₃₃ [pN] | 13.8 | 14.3 | 14.8 | 16.3 | 16.3 | 16.5 | 15.2 |
| γ₁/K₃₃ | 9.3 | 6.7 | 7.0 | 6.7 | 6.7 | 6.8 | 7.8 |
| VHR [%]: Polymerizable compound is not | 96.2 | 89.5 | 94.3 | 96.4 | 96.5 | 96.4 | 96.3 |
| added | | | | | | | |
| VHR [%]: After polymerizable compound is | 97.5 | 94.8 | 96.5 | 97.3 | 97.4 | 97.5 | 97.5 |
| added | | | | | | | |

The liquid crystal compositions LC-1, LC-2, and LC-3 of the invention had a small rotational viscosity (γ₁) and a large elastic constant (K₃₃), and had γ₁/K₃₃ of 7.0, 6.7, and 6.7, respectively, which were values even smaller than that of LC-A in the Comparative Example.

With respect to the liquid crystal display elements using these compositions, a response speed was measured. As a result, LC-1, LC-2, and LC-3 were found to have a satisfactorily high response speed and to be 20% or more faster in the response speed than LC-A. The cell thickness was 3.25 μm, the oriented film was JALS2096, and conditions for measuring a response speed were such that Von was 5 V, Voff was 1 V, the measurement temperature was 25° C., and DMS301, manufactured by AUTRONIC-MELCHERS GmbH, was used.

A voltage holding ratio (VHR) after the UV irradiation was measured. As a result, LC-1, LC-2, and LC-3 were found to have a satisfactorily high voltage holding ratio, which was equivalent to that of LC-A. The cell thickness was 6 μm, the oriented film was AL-1051, and conditions for measuring a VHR were such that the voltage was 1 V, the frequency was 60 Hz, the temperature was 60° C., and VHR-1, manufactured by TOYO Corporation, was used.

A liquid crystal composition LC-B having a γ₁/K₃₃ equivalent to those of LC-1, LC-2, and LC-3 was prepared. The prepared composition was found to be lowered in the voltage holding ratio, as compared to LC-1, LC-2, and LC-3.

The above results have confirmed that the liquid crystal composition of the invention has a satisfactorily small rotational viscosity (γ1), a large elastic constant (K₃₃), a high voltage holding ratio (VHR), and a negative dielectric anisotropy (Δε), the absolute value of which is large, without having lowered the refractive index anisotropy (Δn) and nematic phase-isotropic liquid phase transition temperature (Tₙᵢ), and therefore a liquid crystal display element of a VA mode, a PSA mode, a PSVA mode, or the like using composition has excellent display quality such that the element is free of or has suppressed a display failure, and has high response speed.

With respect to Examples 4 and 5 in which the constituents of the liquid crystal composition are changed, a similar tendency has been confirmed.

### Comparative Example 3, Comparative Example 4, Example 6, and Example 7

Liquid crystal compositions LC-C (Comparative Example 3), LC-D (Comparative Example 4), LC-6 (Example 6), and LC-7 (Example 7) were prepared, and physical properties of the prepared compositions were measured. The constituents of the liquid crystal compositions and the results of the measurement of physical properties are shown in Table 2.

TABLE 2

| | Comparative | | Comparative | |
|---|---|---|---|---|
| | Example 3 | Example 6 | Example 4 | Example 7 |
| | LC-C | LC-6 | LC-D | LC-7 |
| 1V—Cy—Ph5—O2 General formula (I) | | 13 | | 2 |
| 1V—Cy—Cy—Ph5—O2 General formula (I) | | 6 | | |
| 2-Cy—Cy—V1 General formula (I-n) | | | | 20 |
| 3-Cy—Cy—V1 General formula (I-n) | | 8 | 9 | 9 |
| 1V—Cy—Cy—Ph-1 General formula (I-n) | | 4 | | |
| 3-Cy—Cy—V General formula (IV-1) | | | 35 | |
| 3-Cy—Ph5—O2 General formula (II) | 13 | | 2 | |
| 3-Cy—Ph5—O4 General formula (II) | 3 | 3 | | |
| 3-Ph—Ph5—O2 General formula (II) | | | 18 | 18 |
| 3-Cy—Cy—Ph5-3 General formula (II) | | | 10 | 10 |
| 3-Cy—Cy—Ph5—O2 General formula (II) | 6 | | | |
| 3-Cy—Cy—Ph5—O3 General formula (II) | 4 | 4 | | |
| 4-Cy—Cy—Ph5—O2 General formula (II) | | | 5 | 5 |
| 5-Cy—Cy—Ph5—O2 General formula (II) | | | 5 | 5 |
| 2-Cy—Ph—Ph5—O2 General formula (II-B4) | 11 | 11 | | |
| 3-Cy—Ph—Ph5—O2 General formula (II-B4) | 11 | 11 | 12 | 12 |
| 3-Cy—Cy—2 General formula (IV-1) | 18 | 10 | | 15 |
| 3-Cy—Cy—4 General formula (IV-1) | 8 | 8 | | |
| 3-Cy—Cy—5 General formula (IV-1) | 3 | 3 | | |
| 3-Cy—Cy—O1 General formula (IV-1) | 5 | 5 | | |
| 3-Cy—Ph—O1 General formula (IV-2) | 4 | 4 | | |
| 3-Cy—Cy—Ph-1 General formula (N3-1) | 4 | | | |
| 3-Ph—Ph5—Ph-2 General formula (V) | 4.8 | 4.8 | 3.8 | 3.8 |
| 4-Ph—Ph5—Ph-2 General formula (V) | 5 | 5 | | |
| Polymerizable compound General formula (M1-1) | 0.2 | 0.2 | 0.2 | 0.2 |
| Total | 100 | 100 | 100 | 100 |
| Tni [° C.] | 75 | 81 | 75 | 79 |
| Tcn [° C.] | −29 | −28 | −45 | −43 |
| Δn | 0.104 | 0.106 | 0.110 | 0.112 |
| γ₁[mPa · s] | 115 | 117 | 95 | 98 |
| Δε | −3.1 | −3.1 | −2.9 | −2.9 |
| K₃₃ [pN] | 12.5 | 15.2 | 14.8 | 16.1 |
| γ₁/K₃₃ | 9.2 | 7.7 | 6.4 | 6.1 |
| VHR[%]: Polymerizable compound is not added | 96.9 | 96.4 | 89.9 | 96.5 |
| VHR[%]: After polymerizable compound is added | 97.6 | 97.4 | 93.2 | 97.5 |

The liquid crystal composition LC-6 of the invention had a small rotational viscosity (γ₁) and a large elastic constant (K₃₃), and had a γ₁/K₃₃ of 7.7, which was a value even smaller than that of LC-C in the Comparative Example.

With respect to the liquid crystal display elements using these compositions, a response speed was measured. As a result, LC-6 was found to have a satisfactorily high response speed and to be 15% or more faster in the response speed than LC-C. The cell thickness was 3.25 μm, the oriented film was JALS2096, and conditions for measuring a response speed were such that Von was 5 V, Voff was 1 V, the measurement temperature was 25° C., and DMS301, manufactured by AUTRONIC-MELCHERS GmbH, was used.

A voltage holding ratio (VHR) after the UV irradiation was measured. As a result, LC-6 was found to have a satisfactorily high voltage holding ratio, which was equivalent to that of LC-C. The cell thickness was 6 μm, the oriented film was AL-1051, and conditions for measuring a VHR were such that the voltage was 1 V, the frequency was 60 Hz, the temperature was 60° C., and VHR-1, manufactured by TOYO Corporation, was used.

The liquid crystal c composition LC-7 of the invention had a small, rotational viscosity (γ₁) and a large elastic constant (K₃₃)and had a γ₁/K₃₃ of 6.1, which was a value equivalent to or smaller than that of LC-D in the Comparative Example.

With respect to the liquid crystal display elements using these compositions, a response speed was measured. As a result, LC-7 was found to have a satisfactorily high response speed and to be faster in the response speed, than LC-D. The cell thickness was 3.25 μm, the oriented film was JALS2096, and conditions for measuring a response speed were such that Von was 5 V, Voff was 1 V, the measurement temperature was 25° C., and DMS301, manufactured by AUTRONIC-MELCHERS GmbH, was used.

A voltage holding ratio (VHR) after the UV irradiation was measured. As a result, LC-7 was found to have an extremely high voltage holding ratio, as compared to LC-D. The cell thickness was 6 μm, the oriented film was AL-1051, and conditions for measuring a VHR were such thou the voltage was 1 V, the frequency was 60 Hz, the temperature was 60° C., and VHR-1, manufactured by TOYO Corporation, was used.

The above results have confirmed that the liquid crystal composition of the invention has a satisfactorily small rotational viscosity (γ1), a large elastic constant (K₃₃), a high voltage holding ratio (VHR), and a negative dielectric anisotropy (Δε), the absolute value of which is large, without having lowered the refractive index anisotropy (Δn) and nematic phase-isotropic liquid phase transition temperature (Tₙᵢ), and therefore a liquid crystal display element of a VA mode, a PSA mode, a PSVA mode, or the like using the composition has excellent display quality such that the element is free of or has suppressed a display failure, and has high response speed.

### Comparative Example 5, Comparative Example 6, Example 8, Example 9, and Example 10

Liquid crystal compositions LC-E (Comparative Example 5), LC-F (Comparative Example 6), LC-8 (Example 8), LC-9 (Example 9), and LC-10 (Example 10) were prepared, and physical properties of the prepared compositions were measured. The constituents of the liquid crystal compositions and the results of the measurement of physical properties are shown in Table 3.

TABLE 3

| | Comparative | | Comparative | | |
|---|---|---|---|---|---|
| | Example 5 | Example 8 | Example 6 | Example 9 | Example 10 |
| | LC-E | LC-8 | LC-F | LC-9 | LC-10 |
| 1V—Cy—Ph5—O2 General formula (I) | | 5 | | | 6 |
| 1V—Cy—Cy—Ph5—O2 General formula (I) | | 5 | | | 6 |
| 1V—Cy—Ph—Ph5—O2 General formula (I) | | | | | 5 |
| 2-Cy—Cy—V1 General formula (I-n) | | 10 | | 10 | 20 |
| 3-Cy—Cy—V1 General formula (I-n) | | 5 | 11 | 11 | 11 |
| 3-Cy—Cy—V General formula (IV-1) | | | 31.65 | 21.65 | 6.65 |
| 3-Cy—Ph5—O2 General formula (II) | 13 | 10 | 13 | 13 | 13 |
| 5-Cy—Ph5—O2 General formula (II) | | | 6 | 9 | 2 |
| 3-Cy—Cy—Ph5—O2 General formula (II) | | 6.5 | 10 | 9 | 6 |
| 4-Cy—Cy—Ph5—O2 General formula (II) | 9 | 4 | | | |
| 5-Cy—Cy—Ph5—O2 General formula (II) | 5 | | | | |
| 2-Cy—Ph—Ph5—O2 General formula (II-B4) | 8.5 | 5 | 5 | 5 | |
| 3-Cy—Ph—Ph5—O2 General formula (II-B4) | 8.5 | 8.5 | 10 | 8 | 6 |
| 3-Cy—Cy-2 General formula (IV-1) | 23.8 | 18.8 | | | 5 |
| 3-Cy—Cy-4 General formula (IV-1) | 10 | | | | |
| 3-Cy—Ph—O1 General formula (IV-2) | 7 | 7 | | | |
| 3-Ph—Ph5—Ph-2 General formula (V) | 7 | 7 | 12.5 | 12.5 | 12.5 |
| 4-Ph—Ph5—Ph-2 General formula (V) | 8 | 8 | | | |
| 3-Ph—Ph—Ph1—Ph3—F | | | 0.5 | 0.5 | 0.5 |
| Polymerizable compound General formula (M1-1) | 0.2 | 0.2 | 0.35 | 0.35 | 0.35 |
| Total | 100 | 100 | 100 | 100 | 100 |
| Tni [° C.] | 76 | 75 | 76 | 75 | 76 |
| Tcn [° C.] | −28 | −25 | −25 | −56 | −42 |
| Δn | 0.108 | 0.108 | 0.108 | 0.108 | 0.109 |
| γ₁[mPa · s] | 112 | 112 | 94 | 96 | 105 |
| Δε | −2.8 | −2.8 | −2.7 | −2.7 | −2.7 |
| K₃₃ [pN] | 13.7 | 15.0 | 14.0 | 14.4 | 15.5 |
| γ₁/K₃₃ | 8.2 | 7.5 | 6.7 | 6.7 | 6.8 |
| VHR[%]: Polymerizable compound is not added | 96.9 | 96.4 | 91.0 | 92.4 | 95.9 |
| VHR[%]: After polymerizable compound is added | 97.6 | 97.5 | 93.4 | 94.6 | 97.1 |

The liquid crystal composition LC-8 of the invention had a small rotational viscosity (γ₁) and a large elastic constant (K₃₃), and had a γ₁/K₃₃ of 7.5, which was a value even smaller than that of LC-E in the Comparative Example.

With respect to the liquid crystal display elements using these compositions, a response speed was measured. As a result, LC-8 was found to have a satisfactorily high response speed and to be 10% or more faster in the response speed than LC-E. The cell thickness was 3.25 μm, the oriented film was JALS2096, and conditions for measuring a response speed were such that Von was 5 V, Voff was 1 V, the measurement temperature was 25° C., and DMS301, manufactured by AUTRONIC-MELCHERS GmbH, was used.

A voltage holding ratio (VHR) after the UV irradiation was measured. As a result, LC-8 was found to have a satisfactorily high voltage holding ratio, which was equivalent to that of LC-E. The cell thickness was 6 μm, the oriented film was AL-1051, and conditions for measuring a VHR were such that the voltage was 1 V, the frequency was 60 Hz, the temperature was 60° C., and VHR-1, manufactured by TOYO Corporation, was used.

The liquid crystal compositions LC-9 and LC-10 of the invention had a small rotational viscosity (γ₁) and a large elastic constant (K₃₃), and had a γ₁/K₃₃ of about 6.7, which was a value equivalent to that of LC-F in the Comparative Example.

With respect to the liquid crystal display elements using these compositions, a response speed was measured. As a result, LC-9 and LC-10 were found to have a satisfactorily high response speed. The cell thickness was 3.25 μm, the oriented film was JALS2096, and conditions for measuring a response speed were such that Von was 5 V, Voff was 1 V, the measurement temperature was 25° C., and DMS301, manufactured by AUTRONIC-MELCHERS GmbH, was used.

A voltage holding ratio (VHR) after the UV irradiation was measured. As a result, LC-9 and LC-10 were found to have an extremely high voltage holding ratio, as compared to LC-F. The cell thickness was 6 μm, the oriented film was AL-1051, and conditions for measuring a VHR were such that the voltage was 1 V, the frequency was 60 Hz, the temperature was 60° C., and VHR-1, manufactured by TOYO Corporation, was used.

The above results have confirmed that the liquid crystal composition of the invention has a satisfactorily small rotational viscosity (γ1), a large elastic constant (K₃₃), a high voltage holding ratio (VHR), and a negative dielectric anisotropy (Δε), the absolute value of which is large, without having lowered the refractive index anisotropy (Δn) and nematic phase-isotropic liquid phase transition temperature (Tₙᵢ), and therefore a liquid crystal display element of a VA mode, a PSA mode, a PSVA mode, or the like using the composition has excellent display quality such that the element is free of or has suppressed a display failure, and has high response speed.

1. A liquid crystal composition comprising one kind or two or more kinds of compounds having an alkenyl side chain in the liquid crystal composition, the total content of the compounds having an alkenyl side chain in the liquid crystal composition being from 5 to 100% by mass,
wherein the liquid crystal composition contains one kind or two or more kinds of compounds having a 1-propenyl group as the compounds having an alkenyl side chain, and the total content of the compounds having a 1-propenyl group in the compounds having an alkenyl side chain in the liquid crystal composition is from 30 to 100% by mass.

2. The liquid crystal composition according to claim 1, wherein the compound having a 1-propenyl group is one kind or two or more kinds of compounds selected from the group consisting of a compound represented by the following general formula (I) and a compound represented by the following general formula (I-n): 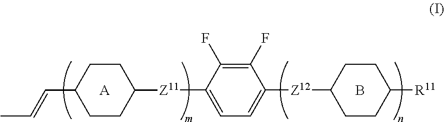
wherein R¹¹ represents an alkyl group having 1 to 8 carbon atoms, an alkoxy group having 1 to 8 carbon atoms, an alkenyl group having 3 to 8 carbon atoms or an alkenyloxy group having 2 to 8 carbon atoms, —CH₂— or two or more —CH₂—, which are not adjacent to each other, in the group each independently may be substituted with —O— or —S—, and one hydrogen atom or two or more hydrogen atoms present in the group each independently may be substituted with a fluorine atom or a chlorine atom;
each of m and n independently represents 0, 1, or 2, with the proviso that m+n is 1, 2, 3, or 4;
each of Z¹¹ and Z¹² independently represents —OCH₂—, —CH₂O—, —CF₂O—, —OCF₂—, —CH₂CH₂—, —CF₂CF₂— or a single bond, and when plural Z¹¹'s or plural Z¹²'s are present, they may be the same or different; and
each of ring A and ring B independently represents a trans-1,4-cyclohexylene group, a 1,4-phenylene group, a 2-fluoro-1,4-phenylene group, a 3-fluoro-1,4-phenylene group, a 3,5-difluoro-1,4-phenylene group, a 2,3-difluoro-1,4-phenylene group, a 1,4-cyclohexenylene group, a 1,4-bicyclo[2.2.2]octylene group, a piperidine-1,4-diyl group, a naphthalene-2,6-diyl group, a decahydronaphthalene-2,6-diyl group, or a 1,2,3,4-tetrahydronaphthalene-2,6-diyl group, and when plural rings A or plural rings B are present, they may be the same or different; 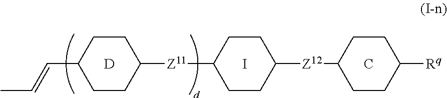
wherein R^{q} represents an alkyl group having 1 to 8 carbon atoms, an alkoxy group having 1 to 8 carbon atoms, an alkenyl group having 3 to 8 carbon atoms or an alkenyloxy group having 2 to 8 carbon atoms, —CH₂— or two or more —CH₂—, which are not adjacent to each other, in the group each independently may he substituted with —O— or —S—, and one hydrogen atom or two or more hydrogen atoms present in the group each independently may he substituted with a fluorine atom or a chlorine atom;
each of Z¹¹ and Z¹² independently represents —OCH₂—, —CH₂—, —CF₂O—, —OCF₂—, —CH₂CH₂—, —CF₂CF₂— or a single bond, and plural Z¹¹'s or plural Z¹²'s are present, they may be the same or different;
d represents 0, 1, or 2; arid
each of ring D, ring I and ring C independently represents a trans-1,4-cyclohexylene group, a 1,4-phenylene group, a 2-fluoro-1,4-phenylene group or a 3-fluoro-1,4-phenylene group, and when plural rings D are present, they may be the same or different.

3. The liquid crystal composition according to claim 2, which comprises one kind or two or more kinds of the compounds represented by the general formula (I).

4. The liquid crystal composition according to claim 2, which comprises one kind or two or more kinds of the compounds represented by the general formula (I-n).

5. The liquid crystal composition according to claim 2, which comprises one kind or two or more kinds of the compounds represented by the general formula (I) and one kind or two or more kinds of the compounds represented by the general formula (I-n).

6. The liquid crystal composition according to claim 1, further comprising one kind or two or more kinds of compounds represented by the following general formula (N3): 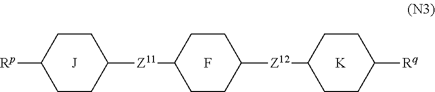
wherein each of Rp and Rq independently represents an alkyl group having 1 to 10 carbon atoms, an alkoxy group having 1 to 10 carbon atoms, an alkenyl group having 2 to 10 carbon atoms, or an alkenyloxy group having 2 to 30 carbon atoms; —CH₂— or two or more —CH₂—, which are not adjacent to each other, in the group each independently may be substituted with —O— or —S—; one hydrogen atom or two or more hydrogen atoms present in the group each independently may be substituted with a fluorine atom or a chlorine atom; each of ring J, ring F and ring K independently represents a trans-1,4-cyclohexylene group, a 1,4-phenylene group, a 2-fluoro-1,4-phenylene group, a 3-fluoro-1,4-phenylene group, a 3,5-difluoro-1,4-phenylene group, a 1,4-cyclohexenylene group, a 1,4-bicyclo[2.2.2]octylene group, a piperidine-1,4-diyl group, a naphthalene-2,6-diyl group, a decahydronaphthalene-2,6-diyl group or a 1,2,3,4-tetrahydronaphthalene-2,6-diyl group; and each of Z11 and Z12 independently represents —OCH2-, —CH2O—, —CF2O—, —OCF2-, —CH2CH2-, —CF2CF2- or a single bond, and when plural Z11's or plural Z12's are present, they may be the same or different, with the proviso that the compound represented by the general formula (I-n) in claim 2 is excluded.

7. The liquid crystal composition according to claim 1, further comprising one kind or two or more kinds of compounds represented by the following general formula (II): 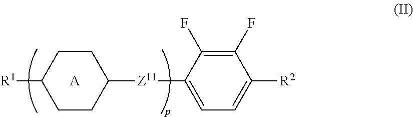
wherein, each of R¹ and R² independently represents mi alkyl group having 1 to 10 carbon atoms, an alkoxy group having 1 to 10 carbon atoms, an alkenyl group having 2 to 10 carbon atoms, or an alkenyloxy group having 2 to 10 carbon atoms; one —CH₂— or two or more —CH₂—, which are not adjacent to each other, present in the group each independency may be substituted with —O— or —S—; one hydrogen atom or two or more hydrogen atoms present in the group each independently may be substituted with a fluorine atom or a chlorine atom; ring A represents a trans-1,4-cyclohexylene group, a 1,4-phenylene group, a 2-fluoro-1,4-phenylene group, a 3-fluoro-1,4-phenylene group,
a 3,5-difluoro-1,4-phenylene group, a 2,3-difluoro-1,4-phenylene group, a 1,4-cyclohexenylene group, a 1,4-bicyclo[2.2.2]octylene group, a piporidine-1,4-diyl group, a naphthalene-2,6-diyl group, a decahydronaphthalene-2,6-diyl group, or a 1,2,3,4-tetrahydronaphthalene-2,6-diyl group; p represents 1, 2, or 3 and when plural rings A are present, they may be the same or different; and Z13 represents —OCH2-, —CH2O—, —CF2O—, —OCF2-, —CH2CH2-, —CF2CF2- or a single bond and when plural Z11's are present, they may be the same or different, with the proviso that the compound represented by the general formula (I) in claim 2 is excluded.

8. The liquid crystal composition claim 1, further comprising one kind or two or more kinds of compounds selected from the group consisting of compounds represented by the following general formulae (IV-1) to (IV-3): 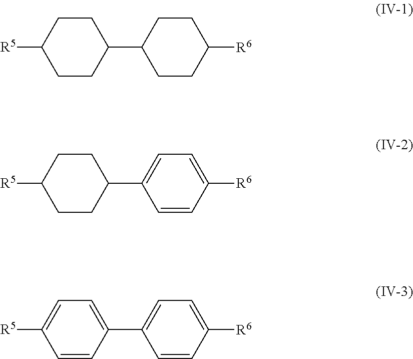
wherein R5 represents an alkyl group having 1 to 5 carbon atoms or an alkenyl group having 2 to 5 carbon atoms, and R6 represents an alkyl group having 1 to 5 carbon atoms, an alkoxy group having 1 to 5 carbon atoms, an alkenyl group having 2 to 5 carbon atoms or an alkenyloxy group having 2 to 5 carbon atoms; one —CH2- or two or more —CH2-, which are not adjacent to each other, present in the group each independently may be substituted with —O— or —S—; and one hydrogen atom or two or more hydrogen atoms present in the group each independently may be substituted with a fluorine atom, with the proviso that the compound represented by the general formula (I-n) in claim 3 is excluded.

9. The liquid crystal composition according to claim 1, further comprising one kind or two or more kinds of compounds represented by the following general formula (V): 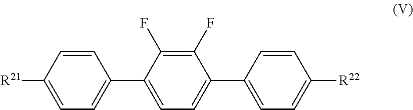
wherein each of R²¹ and R²² independently represents an alkyl group having 1 to 8 carbon atoms, an alkoxy group having 1 to 8 carbon atoms, an alkenyl group having 2 to 8 carbon-atoms-or an alkenyloxy group having 2 to 8 carbon atoms; one —CH₂— or two or more —CH₂—, which are not adjacent to each other, present in the group each independently may be substituted with —O— or —S—; and one hydrogen atom or two or more hydrogen atoms present in the group each independently may be substituted with a fluorine atom, with the proviso that the compound represented by the general formula (I) in claim 3 is excluded.

10. The liquid crystal composition according to claim 1, further comprising one kind or two or more kinds of polymerizable compounds.

11. The liquid crystal composition according to claim 10, wherein the polymerizable compound is a compound represented by the following general formula (RM-1): 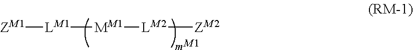
wherein each of Z^{M1} and Z^{M2} independently represents the following: 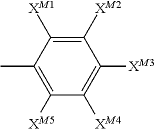
wherein X^{M1} to X^{M5} represent a hydrogen atom, a fluorine atom or the following:
-S^{M1}-R^{M1}
with the proviso that at least one of X^{M1} to X^{M5} represents the following:
-S^{M1}-R^{M1}
wherein S^{M1} represents an alkylene group having 1 to 12 carbon atoms or a single bond, and —CH₂— in the alkylene group may be substituted with an oxygen atom, —COO—, —OCO— or —OCOO—, with the proviso that oxygen atoms are not directly bonded to each other; and R^{M1} represents any of the following formulae (R-1) to (R-15): 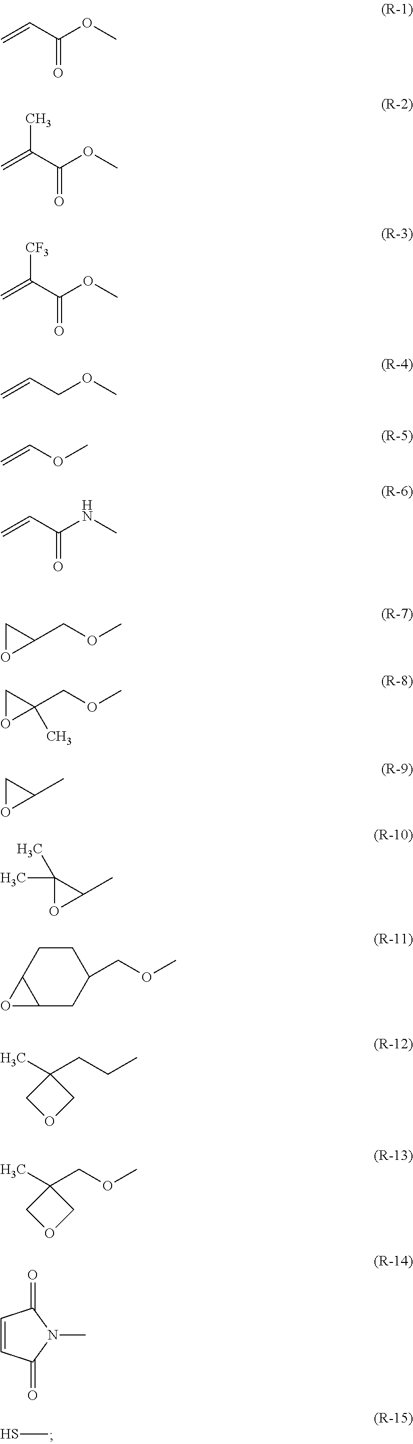
each of L^{M1} and L^{M2} independently represents a single bond, —O—, —CH₂—, —OCH₂—, —CH₂O—, —CO—, —C₂H₄—, —COO—, —OCO—, —CH═CH—COO—, —COO—CH═CH—, —OCO—CH═CH—, —CH═CH—OCO—, —COOC₂H₄—, —OCOC₂H₄—, —C₂H₄OCO—, —C₂H₄COO—, —OCOCH₂—, —CH₂COO—, —CH═CH—, —CF═CH—, —CH═CF—, —CF═CF—, —CF₂—, —CF₂O—, —OCF₂—, —CF₂CH₂—, —CH₂CF₂—, —CF₂CF₂— or —C≡C—, and when plural L^{M2}'s are present, they may be the same or different;
M^{M1} represents a 1,4-phenylene group, a 1,4-cyclohexylene group, or a naphthalene-2,6-diyl group, and M^{M1} each independently may be unsubstituted or a hydrogen atom contained in the group may be substituted with a fluorine atom, a chlorine atom, an alkyl group, a halogenated alkyl group, a halogenated alkoxy group or an alkoxy group, each having 1 to 8 carbon atoms, a nitro group, or the following:
-S^{M1}-R^{M1}; and
m^{M1} represents 0, 1, or 2, with the proviso that when X^{M1}'s to X^{M5}'s, S^{M1}'s, R^{M1}'s, L^{M2}'s and/or M^{M1}'s are present plurally, they may be the same or different.

12. The liquid crystal composition according to claim 1, which has a dielectric anisotropy (Δε) at 25° C. in the range of from −2.0 to −8.0, a refractive index anisotropy (Δn) at 20° C. in the range of from 0.08 to 0.14, a viscosity (η) at 20° C. in the range of from 5 to 30 mPa·s, a rotational viscosity (γ1) at 20° C. in the range of from 50 to 150 mPa·s, and a nematic phase-isotropic liquid phase transition temperature (Tₘ) in the range of from 60 to 120° C.

13. A liquid crystal display element using the liquid crystal composition according to claim 1.

14. A liquid crystal display element for active matrix driving, using the liquid crystal composition according to claim 1.

15. A liquid crystal display element for a VA mode, a PSA mode, a PSVA mode, an IPS mode, or an ECB mode, using the liquid crystal composition according to claim 1.
